(19) United States
(12) Patent Application Publication
(10) Pub. No.: US 2015/0089409 A1
(43) Pub. Date: Mar. 26, 2015

(54) SYSTEM AND METHOD FOR MANAGING OPINION NETWORKS WITH INTERACTIVE OPINION FLOWS

(71) Applicants: Alexander Asseily, London (GB); Mark Asseily, London (GB); Soumyadeep Paul, Mumbai (IN); Daniel Kristopher Harvey, London (GB); Spencer Cameron Kelly, London (GB); Helen Louise Flatley, Whitechapel (GB); Philip James Edward Gribbon, Hoxton (GB)

(72) Inventors: Alexander Asseily, London (GB); Mark Asseily, London (GB); Soumyadeep Paul, Mumbai (IN); Daniel Kristopher Harvey, London (GB); Spencer Cameron Kelly, London (GB); Helen Louise Flatley, Whitechapel (GB); Philip James Edward Gribbon, Hoxton (GB)

(73) Assignee: EQUAL MEDIA LIMITED, Sevenoaks Kent (GB)

(21) Appl. No.: 14/238,193

(22) PCT Filed: Aug. 14, 2012
(86) PCT No.: PCT/IB2012/001581

§ 371 Date: Oct. 8, 2014

Related U.S. Application Data
(60) Provisional application No. 61/523,823, filed on Aug. 15, 2011.
(60) Provisional application No. 61/625,560, filed on Apr. 17, 2012.
(60) Provisional application No. 61/650,240, filed on May 22, 2012.

(51) Int. Cl. G06F 3/0481; G06F 17/28; H04L 12/18

(52) U.S. Cl. CPC G06F 3/0481; H04L 12/1813; G06F 17/28
USPC 715/765

(57) ABSTRACT

The field of the disclosure relates generally to systems and methods for managing opinion networks with interactive opinion flows and more particularly, but not exclusively, to systems and methods for collecting and analyzing electronic opinion data. A method for analyzing electronic opinion data includes the steps of receiving electronic opinion data, wherein the opinion data includes words of a natural language; mapping the opinion data to unifying opinion objects, the unifying opinion objects provided as a controlled natural language; and providing a presentation having at least one portion corresponding to at least one of said unifying opinions. In an alternative embodiment, the method further includes ranking the unifying opinion objects in an opinion graph to generate per-user relevance.

### CROSS-REFERENCE TO RELATED APPLICATIONS

This application claims priority to: U.S. Provisional Application Ser. No. 61/523,823, filed on Aug. 15, 2011; U.S. Provisional Application Ser. No. 61/625,560, filed on Apr. 17, 2012; and U.S. Provisional Application Ser. No. 61/650,240, filed on May 22, 2012. Priority to these provisional applications is expressly claimed, and the disclosures of respective provisional applications are hereby incorporated by reference in their entireties and for all purposes.

### FIELD

The present disclosure relates generally to systems and methods for managing opinion networks with interactive opinion flows and more particularly, but not exclusively, to systems and methods for collecting and analyzing electronic opinion data.

### BACKGROUND

Web-based systems and data networks provide users with an interactive experience, for example, through contributions to Web-based content (e.g., Web pages). Web-logs (“blogs”), online forums, and so on allow users to interact with each other by creating/editing Web content accessible to other users. A large portion of this Web content reflects a user's sentiment/opinion toward various objects (e.g., electronic commerce products, politics, and celebrities). To facilitate an understanding of the increasing volume of sentiment/opinion data, opinion mining (or sentiment analysis) is often used to process and extract subjective information from the data.

Approaches to opinion mining, aggregation, and sentiment analysis have conventionally attempted to perform broad sentiment analysis on larger blocks of text. These approaches have text classification as a primary aim, and endeavor to identify overall sentiment polarity, with best results typically obtained in review sites where the object is easily identified. These conventional approaches rely heavily upon “bag-of-words” statistical relevance and prior-polarity tagging of specific subjective keywords. The “bag-of-words” model quantizes extracted text—such as from a sentence or a document—as an unordered collection of visual words. Polarity-tagging includes classifying certain text as positive, negative, or neutral. Similar methods have been applied in blogs and news articles, or on micro-blogging platforms (e.g., Twitter® and so on), with varying results.

One drawback of these conventional approaches is a lack of precision in identifying the entity or concept which is the object of the opinion. Some conventional approaches use a triangulation method to calculate proximity of subjective keywords with known entities within a text. These approaches have more success in identifying sentiment around particular objects, but limited understanding of the actual opinion. For example, the term “big” may not have an associated prior-polarity, yet may find meaning in a particular context that traditional methods fail to capture. Other conventional approaches are restricted to hand-annotated training data, which quickly becomes outdated.

In view of the foregoing, a need exists for an improved opinion network and method for opinion mining, aggregation, and sentiment analysis in an effort to overcome the aforementioned obstacles and deficiencies of prior art systems.

### SUMMARY

The field of the disclosure relates generally to systems and methods for managing opinion networks with interactive opinion flows and more particularly, but not exclusively, to systems and methods for collecting and analyzing electronic opinion data. In one embodiment, a method for analyzing opinion data includes the steps of receiving electronic opinion data, wherein the opinion data includes words of a natural language; mapping the opinion data to unifying opinion objects, the unifying opinion objects provided as a controlled natural language; and providing a presentation having at least one portion corresponding to at least one of said unifying opinions.

In an alternative embodiment, the method further includes ranking the unifying opinion objects in an opinion graph to generate per-user relevance.

This summary is provided to introduce the subject matter of the disclosure and not intended to identify essential features of the claimed subject matter, nor is it intended for use in determining the scope of the claimed subject matter. Other systems, methods, features, and advantages of the disclosure will be or will become apparent to one with skill in the art upon examination of the following figures and detailed description. It is intended that all such additional systems, methods, features, and advantages be included within this description, be within the scope of the disclosure, and be protected by the accompanying claims.

### BRIEF DESCRIPTION OF THE DRAWINGS

In order to better appreciate how the above-recited and other advantages and objects of the disclosure are obtained, a more particular description of the embodiments briefly described above will be rendered by reference to specific embodiments thereof, which are illustrated in the accompanying drawings. It should be noted that the components in the figures are not necessarily to scale, emphasis instead being places upon illustrating principles of the disclosure. Moreover, in the figures, like reference numerals designate corresponding parts throughout the different views. However, like parts do not always have like reference numerals. Moreover, all illustrations are intended to convey concepts, where relative sizes, shapes, and other detailed attributes may be illustrated schematically rather than literally or precisely.

FIG. 1 is a schematic drawing illustrating an exemplary opinion network-based computing environment in accordance with a preferred embodiment of the present disclosure;

FIG. 2 is a schematic diagram depicting aspects of an example opinion capture server of FIG. 1 in accordance with one embodiment of the present disclosure;

FIG. 3A is a schematic diagram further detailing the system architecture of an example opinion capture server, as shown in FIG. 1, in accordance with one embodiment of the present disclosure;

FIG. 3B is another schematic diagram further detailing the system architecture of an example opinion capture server of FIG. 1;

FIG. 4 is a functional diagram depicting aspects of an example opinion encoding process;

FIG. 5 is a functional diagram depicting aspects of an example entity spotting and disambiguation process in accordance with at least one embodiment of the disclosure;

FIG. 6 is a schematic diagram depicting aspects of an example opinion graph modeled in accordance with at least one embodiment of the disclosure;

FIG. 7 is a schematic diagram depicting aspects of an example opinion aggregation using semantic relationships in accordance with at least one embodiment of the disclosure;

FIG. 8 is a schematic diagram illustrating aspects of an example ranking process in accordance with an embodiment of the disclosure; and

FIGS. 9A-10D are schematic diagrams depicting aspects of an example graphical user interface for participating in an interactive opinion network flow in accordance with at least one embodiment of the disclosure.

### DETAILED DESCRIPTION OF THE PREFERRED EMBODIMENTS

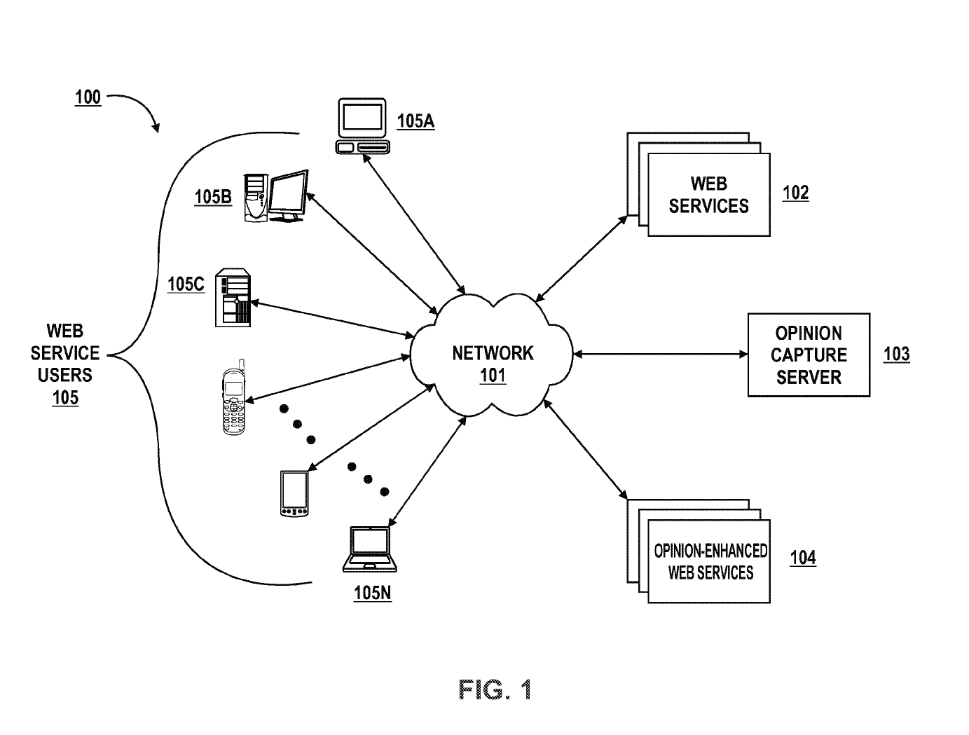

In accordance with at least one embodiment of the disclosure, a network-based computing system may be used to maintain and analyze a rich opinion network. As opinion networks grow, a method for enabling users to express their ideas, connect them to a wider community of related users, content, and opinions, and provide a platform to interact can mobilize communities and impact the wider world. This result can be achieved, according to one embodiment disclosed herein, by an opinion network-based computing system 100 as illustrated in FIG. 1.

The opinion network-based computing system 100 includes a data network 101, configured to access a variety of Internet Services, such as, the World-Wide Web (“Web”)—a well-known data exchange system over the Internet. The Web is commonly used to access electronic content using an application Web browser. By way of illustration, the data network 101 may include one or more Local Area Networks (“LANs”), a Wide Area Network (“WAN”) (e.g., Internet Protocol (“IP”) network), and/or mobile/cellular wireless networks connected to one another. Communication/data exchange with network 101 may occur via any common high-level protocols (e.g., Transfer Control Protocol (“TCP”)/IP, User Datagram Protocol (“UDP”), and so on) and may comprise differing protocols of multiple networks connected through appropriate gateways. The communication/data exchange supports both wired and wireless connections.

Web service users 105 can access various network resources—such as Web services 102, opinion capture server 103, and opinion-enhanced Web services 104—over data network 101 using user devices 105A, 105B, 105C, and 105N. In one embodiment, Web services 102 and opinion-enhanced Web services 104 represent Web pages, each uniquely identifiable via Uniform Resource Locators (“URL”), accessible using any common networking protocol (e.g., HyperText Transfer Protocol (“HTTP”), HTTP Secure (“HTTPS”), Transport Layer Security (“TLS”), and Secure Sockets Layer (“SSL”)) requests.

User devices 105A, 105B, 105C, and 105N are preferably Internet-based communication systems and include, but are not limited to, desktop computers, laptop computers, mobile phones, personal digital assistants (“PDAs”), multimedia players, set top boxes, and other programmable consumer electronics, multiprocessor systems, microprocessor-based systems, and distributed computing environments.

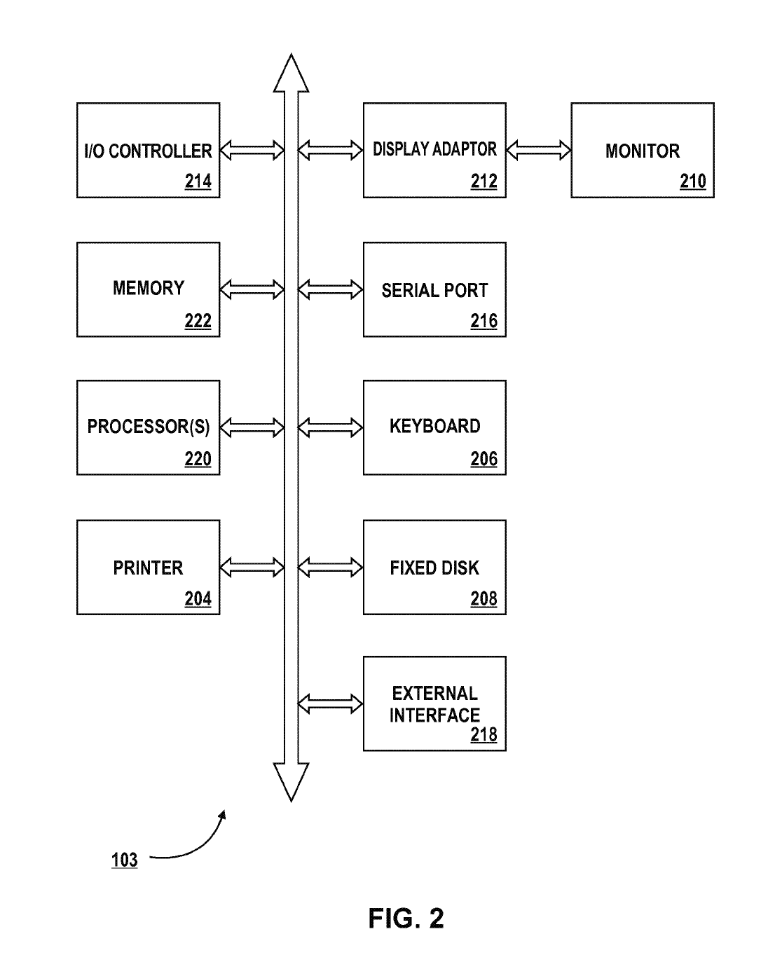

As discussed above, conventional approaches to opinion mining, aggregation, and analysis perform broad sentiment analysis on larger blocks of text, rely heavily on “bag-of-words” statistical relevance and prior polarity tagging, calculate proximity of subjective words using a triangulation method with known entities, and so on. While these approaches may be effective for an object, entity, or concept that is easily identifiable, these techniques continue to lack precision in identifying the object of unstructured opinions and variable entities. Approaches restricted to hand-annotated data for fully understanding the opinion data are quickly outdated. Accordingly, FIG. 2 provides one embodiment of opinion capture server 103 configured to address these issues.

Turning to FIG. 2, opinion capture server 103 is schematically illustrated in further detail. The subsystems shown in FIG. 2 are interconnected via a system bus 202. As an example, opinion capture server 103 includes a fixed disk 208 and a monitor 210 coupled to a display adapter 212. An input device/keyboard 206 is also coupled to system bus 202 to receive user input to server 103. Peripherals and additional input/output (“I/O”) devices couple to an I/O controller 214 and can be connected to server 103 by any number of means known in the art (e.g., serial port 216). For example, the serial port 216 or an external interface 218 connects server 103 to data network 101 or other devices/systems not shown (e.g., mouse, scanner, and so on). An optional printer 204 is also shown connected to system bus 202. The interconnection via the system bus 202 allows one or more processors 220 to communicate with each subsystem and to control the execution of instructions that may be stored in a system memory 222 and/or the fixed disk 208, as well as to exchange information between subsystems.

Both the system memory 222 and the fixed disk 208 may embody tangible computer-readable mediums. As one of ordinary skill in the art would appreciate, system memory 222 and fixed disk 208 may also be any type of mass storage device or storage medium, such as, for example, magnetic hard disks, floppy disks, cloud storage, optical disks (e.g., CD-ROMs), flash memory, DRAM, and a collection of devices (e.g., Redundant Array of Independent Disks (“RAID”)). Although shown in FIG. 2 as residing on the same computing device, it should similarly be understood that memory 222 and disk 208 may reside on different computing devices in communication with one another.

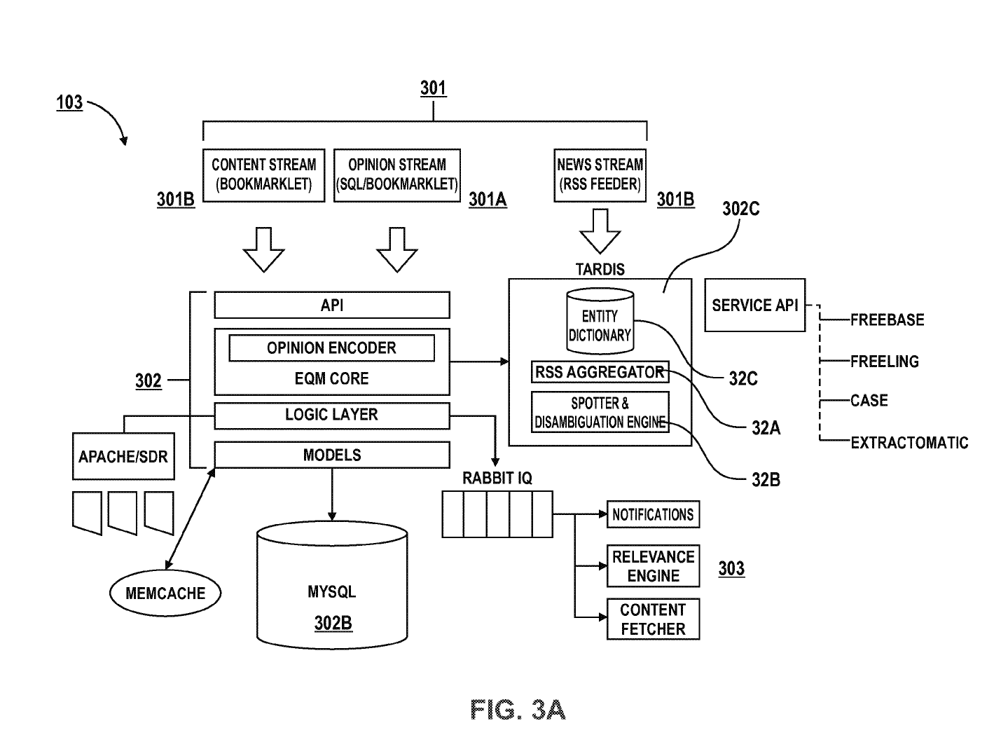

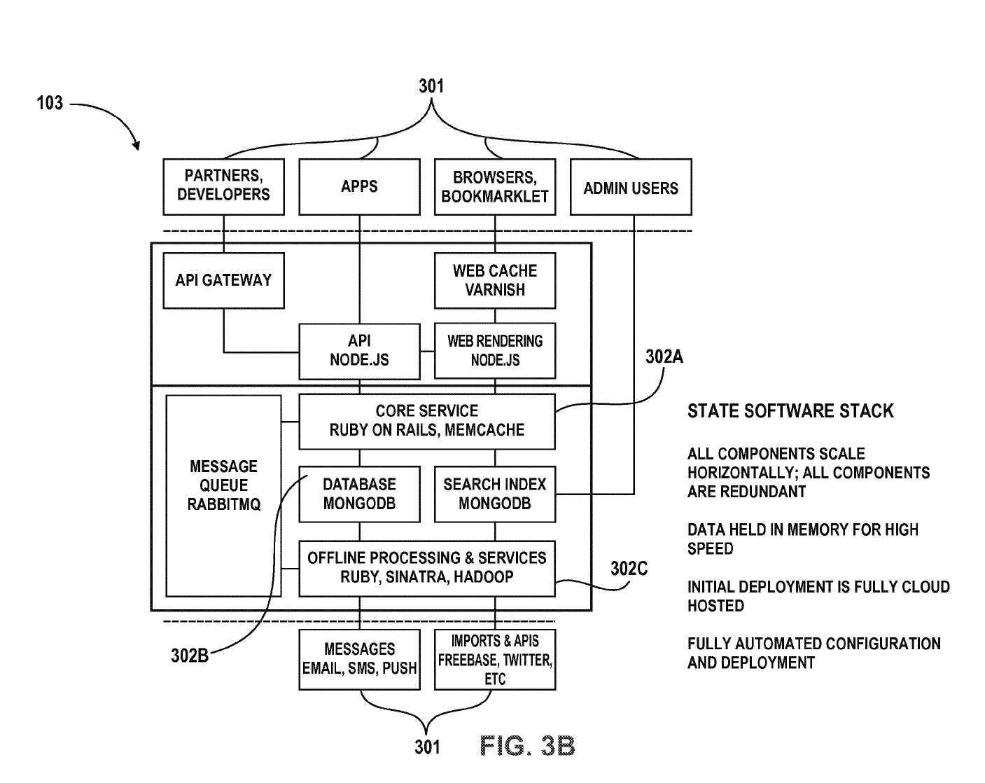

FIG. 3A illustrates details of the system architecture of server 103 in response to electronic opinion data 301. Server 103 includes an offline-processing module 302C having a spotting and disambiguation engine 32B and a Really Simple Syndication (“RSS”) feed aggregator 32A for organizing input data 301 into particular subject domains. The offline-processing module 302C may also include an entity dictionary database 32C for storing a plurality of entities extracted from opinions. In a preferred embodiment, database 32C is organized as an object oriented relational database (e.g., MySQL), although it should be understood that any other hierarchical- or network-based database model may be used. Server 103 further includes a database 302B. Similar to entity dictionary database 32C, database 302B is organized as an object oriented relational database (e.g., MySQL), although it should be similarly understood that any other hierarchical- or network-based database model may be used. It should be further understood that entity dictionary database 32C and database 302B may reside on the same device or different computing devices in communication with one another.

The system, apparatus, methods, processes, and operations for processing electronic opinion data 301 described herein may be wholly or partially implemented in the form of a set of instructions executed by one or more programmed computer processors (e.g., processor(s) 220), including a central processing unit (“CPU”) or microprocessor. The set of instructions may be stored on a computer readable medium, such as memory 222 or fixed disk 208. For example, FIG. 3B illustrates another sample architecture for a set of instructions, similar to FIG. 3A, as stored on server 103.

Returning to FIG. 3A, server 103 is shown to process at least two types of electronic input data 301: (1) opinion data 301A; and (2) content data 301B. Web service users 105 may submit input data 301 (i.e., opinion data 301A and content data 301B), including opinions, actively via a Web site, mobile application, bookmarklet, and/or widgets from their user devices 105A, 105B, 105C, and 105N. For example, a bookmarklet tool enables users 105 to contribute opinions on specifically selected entities, or about a Web page, from any page on the Web. This bookmarklet tool dynamically renders a selected Web page, recognizes entities within the text via natural language processing, and allows users to contribute an opinion about the entities, media objects or sections of the text within an article. Users 105 similarly may publish opinions on existing platforms, such as social networking platforms. Publishing opinions on existing social networking platforms virally promotes the growth of the opinion network.

Additionally, the electronic input data 301 includes words of a natural language (e.g., English), sentence fragments of a natural language, sentences, and graphics/video/audio corresponding to words of a natural language. As used herein, “words of a natural language” should be understood to include phrases of a natural language (e.g., “over the moon”). For graphics/video/audio corresponding to words of a natural language, well known graphics processing, optical character recognition, audio processing (e.g., voice recognition and speech-to-text analysis), and video processing can be used to translate a variety of opinion data to electronic input data 301.

Opinion capture server 103 passes the electronic input data 301 to a core service engine 302 through an application programming interface (“API”). This interface allows users 105 to quickly and easily create opinion structures for precise data and accurate aggregation. APIs describe the ways in which a particular task is performed and are specifications intended to be used as an interface by software components to communicate with each other. APIs may include specifications for routines, data structures, object classes, and variables. Each specification may include a complete interface, a single function, or a set of APIs. The use of APIs is well known and understood by those of ordinary skill in the art.

As input data 301 includes opinions from various sources, users 105 often provide input data 301 in a variety of structures. For example, input data 301 may be highly structured (e.g., opinions via Last.fm); whereas, in other cases, input data 301 lacks any consistent structure (e.g., opinions via Twitter®). In one embodiment, a controlled natural language interface may guide user 105 to capture and model human opinions of input data 301 in a structured, machine-readable form. The natural language interface extracts the essence of the opinion from input data 301 without devaluing the content or imposing significant constraints on expressivity. Users 105 may actively structure their opinions through the guided input flow, in accordance with the natural language interface, or by using predefined syntax.

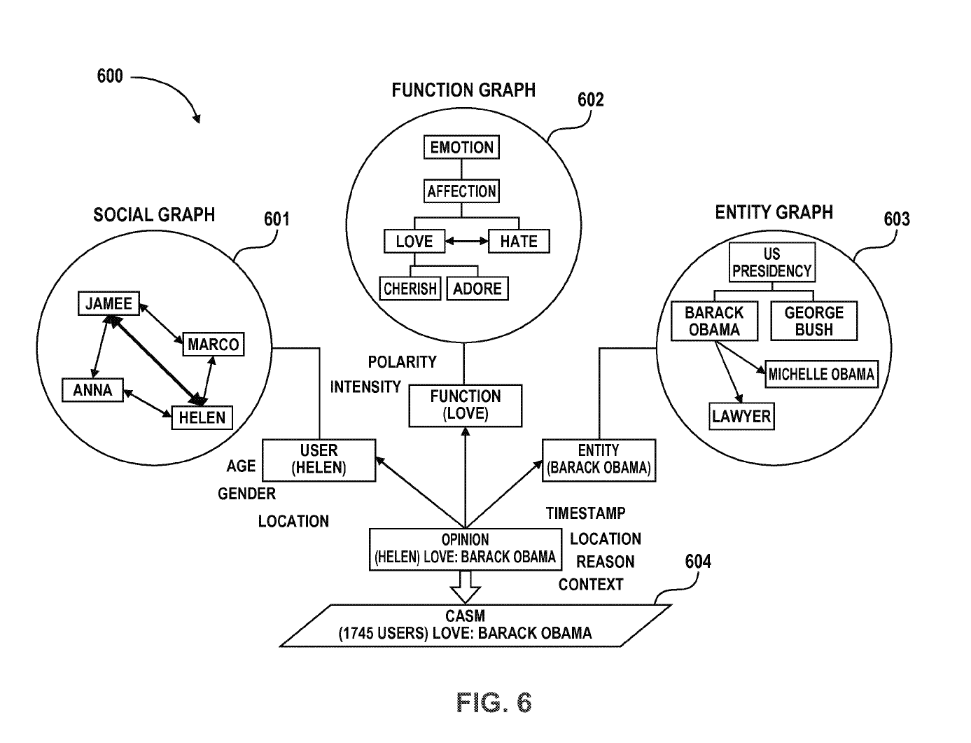

In one example, users 105 submit opinions to server 103 using a Web browser on their user device 105A, 105B, 105C, and 105N. Server 103 provides an opinion entry interface that incorporates predictive text and/or “auto-complete” techniques. A user 105 may start typing a first few letters in a text entry box on a Web page or in an application for a mobile device. In response, auto-complete options may be presented, which include a combination of stored entities and opinion words. User 105 can then decide to complete the word or use the auto-complete suggestion. As a specific example, if the user 105 inputs an entity word (e.g., “trains”), server 103 would then require an opinion word (e.g., “love” or “hate”) to apply to the entity. Server 103 therefore provides auto-complete suggestions for either the top 5 trending opinion words used in conjunction with that entity or user's 105 frequently used opinions. Similarly, if the user 105 entered an opinion word, the server 103—requiring an entity to apply it to—would suggest the top 5 trending topics used in conjunction with the opinion word from a user's opinion graph (e.g., a user 105 entering “love” is presented with films and cameras in the user's 105 opinion graph), which will be further discussed below with reference to FIG. 6. Accordingly, guiding user input provides opinion structures that can be fed directly into the opinion graph and connected to related entities, users 105, and opinions.

In order to create structured opinion data, an example opinion entry interface of server 103 may capture the following dimensions of each opinion:

Object: This is the entity about which the opinion is being expressed. These are uniquely identified and related to one another in an entity graph. This is linked to open datasets—such as Freebase (and consequently the Linked Open Data graph)—and, therefore, is continually being updated and extended. The object may also be a geographical place (e.g., city or neighborhood) or venue (e.g., restaurant, café, bar, park, attraction, etc.). Additionally, users 105 can upload photographs or videos that then become Objects in database 302B, or users 105 can refer to existing resources on the Web via hyperlinks (e.g., articles, videos, pages, etc.).

Subject: This is the opinion-giver (i.e., user 105). The server 103 may draw on data from the opinion-giver's existing profile on a social media platform, activities on the Web, location, and profile information to add relevance/detail to the data presented. Users 105 in the system may be individuals, groups, organizations, or companies.

Affect: This is the subjective content within the opinion (i.e., the meaning of the opinion word). Server 103 may capture the semantic meaning of this word and related words (e.g., synonyms, antonyms, and hypernyms). In one embodiment, affect is derived from links to a lexical database (e.g., WordNet), which semantically clusters concepts and relates them to a hypernym taxonomy. For example, the affect may reference one or more synsets. A synset is a group of opinion words that are synonyms or have sufficiently similar meaning.

Intensity: This is the intensity with which opinions are expressed. This is captured at the point of opinion entry to server 103 on an intensity slider, which forms part of the opinion entry user interface (“UI”), or through natural language analysis of the text. Words that contain intrinsic intensity are marked up in a function table, but more commonly intensity is derived from particular modifiers (e.g., “very”), which map the function along an intensity spectrum.

Polarity: This is the sentiment polarity of the opinion itself—as compared to the individual opinion word—as a whole, taking into account negation and modifiers. All functions are stored in a database and tagged with prior-polarity (i.e., they contain intrinsic sentiment data, such as from a hand annotated dataset). However, the server 103 can also redress the overall polarity of the opinion based on the modifiers used or the entity it relates to.

Context: This is the location on the Web where the opinion is being expressed. This might be a Web page or an article/item of media identified on the Web. Context also includes reactions to another opinion. Context may form a node within an opinion graph to allow a user 105 to see which opinions have been prompted by that particular page.

Condition: The opinion can be qualified using a trigger word (e.g., “because” or “when”) followed by a natural language statement to add extra metadata to the opinion.

Reasons: This is a natural language comment attached to an opinion to provide additional justification or explanation for the expressed opinion. Users 105 may express multiple reasons for holding an opinion.

The opinion entry interface also offers the ability to model discourse surrounding an idea over time. For example, server 103 detects when a user 105 has reacted to another user 105, whether they agreed or disagreed, the opinion reaction, and the resulting action taken. Server 103 isolates temporal moments, which prompted shifts in opinion, and attaches that to meaning, rather than tracing the frequency of a particular string from the Web. This facilitates development of a rhizomatic opinion network system 100 around conversation, which grows in intelligence over time and with extensive use.

As mentioned above, a controlled natural language interface may be provided to guide the user when inputting opinions and enforce a particular structure. In a preferred embodiment, this controlled natural language is modeled on Resource Description Framework (RDF) triples. RDF is a standard model for data interchange on the Web and is well understood and appreciated. By example, a controlled natural language interface may encode opinions into various forms including, but not limited to:

Status: [User 105]:[adjective]
e.g., “Happy”
   Status forms capture the mood or self-perception of the user. This type of emote consists of a single word, commonly prefixed with “I feel . . . ” and is usually followed by a stative adjective.

Intent: [User 105]:[verb]:[noun phrase]
e.g., “love:falafel”
   Intent forms capture the user's 105 expression of an intention towards an object and often includes an emotive verb, such as “love” or “hate.”

Property: [User 105]:[noun phrase]:[adjective]
e.g., “London:awesome”
   Property forms are generated when a user 105 attributes a property, or description, to an object.

Connection: [User 105]:[noun phrase]:[verb]:[noun phrase]
e.g., “Nuclear power plants:reduce:Global Warming”
e.g., “George Bush:destroyed:Iraq”
e.g., “Obama should win:U.S. election”
   Connection forms are generated when user 105 connects two objects using a verb, thereby making a statement they hold to be true.

These basic structures are extendable, and constantly evolving in response to user 105 activity. For example, users 105 may add a condition to their opinion with a trigger word that is either pre-defined or parsed to provide additional information surrounding these statements. This may include temporal or geographical restrictions on the validity of the opinion (e.g., “hate:London when it's rainy”) or a reason for the opinion (e.g., “hate:London because it's rainy”). If a particular (i.e., unknown) trigger word becomes statistically significant, server 103 elevates the trigger word and similar conditions are aggregated around it, such that the qualifiers are constantly evolving through user 105 interaction.

Users 105 may also impose a qualifier on the individual components of the opinion (e.g., “hate:slow trains” or “red iPods:brilliant”). Additional opinion structures include conjunctions—either subordinating or coordinating—that allow multiple opinions to be tied together, or reliant on each other.

Alternatively, where users 105 are not guided by a controlled natural language interface, opinion capture server 103 is configured to translate unstructured, natural language input data 301 into the aforementioned structures. The core service engine 302, therefore, includes an opinion encoding module 302A for translating the electronic input data 301 into a unifying model (e.g., aided by the constraints of the controlled natural language interface).

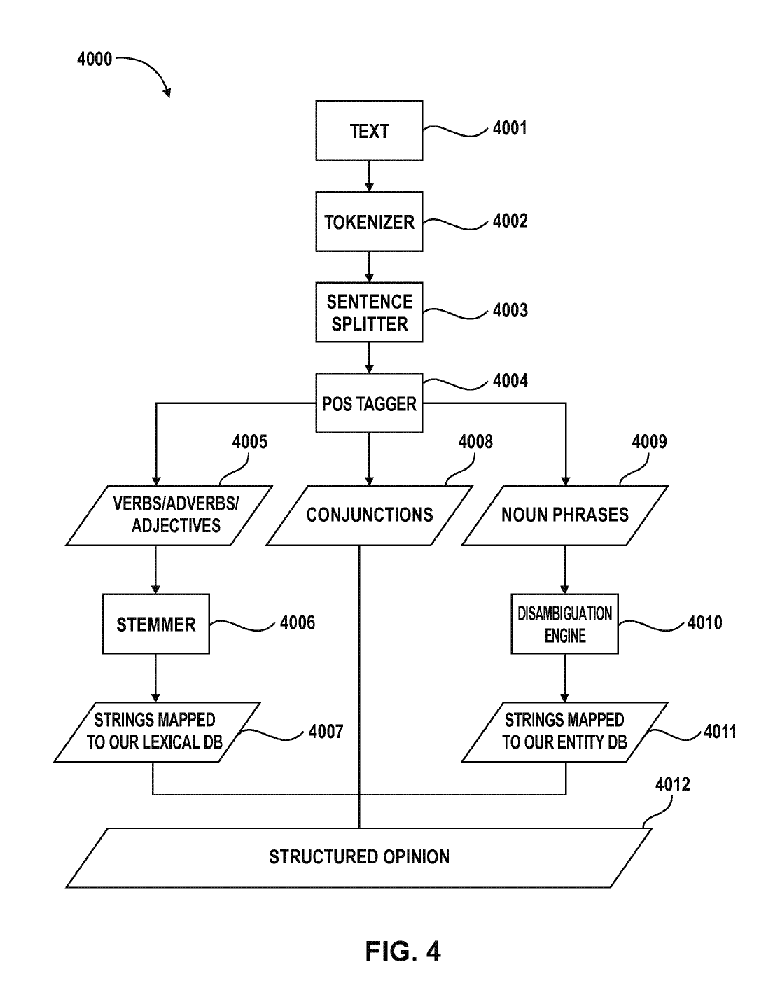

In a preferred embodiment, FIG. 4 illustrates a process 4000 for translating the input data 301 that may be executed by opinion encoding module 302A. As illustrated, opinion encoding module 302A receives input data 301, which typically contains free-form text (action block 4001). The input data 301 is tokenized to obtain individual words, phrases, symbols, or other token elements (action block 4002). Once tokenized, the tokens are lemmatized such that opinion encoding module 302A can map variant word forms to a structured lexicon (action block 4003). In conjunction, the lemmatized tokens are run through a part-of-speech (“POS”) tagger to identify key verbs, adjectives, the entities (e.g., nouns) to which they apply, and so on (action block 4004). The entities extracted from the opinion (e.g., noun phrases) (action block 4009) are then run though the contextual disambiguation engine 32B to rank the correct definition of the word or entity based on domain recognition and the statistical frequency of the words within that domain (action block 4010). These ranked entities are mapped to entity dictionary database 32C (action block 4011).

From the POS tagger (action block 4004), verbs/adverbs/adjectives are tied together to the appropriate POS for which they qualify (action block 4005). In one embodiment, a stemmer subsequently reduces each verb/adverb/adjective to its root word (e.g., “fishing,” “fished,” and “fishes” are each reduced to “fish”) to facilitate mapping variations of each word (action block 4006). Each root word then is mapped to a database, accessible over data network 101 (e.g, database 302B or a third-party database, such as Freebase) (action block 4007). Mapping to a third-party database provides instant references to similar topics across the Web, thereby providing users 105 immediate access to additional resources related to an opinion's topic. Conjunctions (either subordinating or coordinating) (action block 4008) allow multiple opinions to be tied together or reliant on each other are also reflected in the resultant structured opinion (end block 4012).

As an additional input 301 source, structured opinions from elsewhere on the Web can be translated into specific opinions within the site and claimed by users 105. For example, a user 105 may convert Facebook® “likes” or “dig”ed articles from “digg.com” into structured opinions. The user 105 provides authentication credentials (e.g., username and password) to server 103 to access the user's 105 “liked” or “dig”ed items. Once parsed and tagged, spotting and disambiguation engine 32B identifies entities, disambiguates, and maps the opinion entity to a Freebase topic based on a corresponding Web page (e.g., Facebook® Web page or Wikipedia® entry). A confidence level may be maintained for each identified entity based on the method of disambiguation. A confidence threshold is then used to filter out less confident imported opinions. Optionally, the proposed opinions may be presented to the user 105 for manual filtering/selection. A similar mechanism may be provided for topic-based services, where users 105 can import positive or negative ratings, such as consumer media/product reviews (e.g., last.fm, Netflix®, and Amazon®). Users 105 then will be able to view their collected opinions, expressed on multiple platforms and in multiple networks, in a centralized location.

Returning to FIG. 3A, content data 301B also may be extracted from various Web pages (e.g., news streams) for similar processing. The content data 301B populates entity dictionary database 32C to establish a trendingness ranking for individual entities, both globally and per specified domains. This analysis may be performed in the offline processing module 302C. In one embodiment, a number of API services may be used to perform the offline processing including Freebase, Extractomatic, and a spotting engine 32B (e.g., CASE).

The spotter and disambiguation engine 32B draws on both statistical methods and linguistic parsers to identify relevant entities within input data 301, and selects an appropriate disambiguation for a given term based on the context in which it is found. Spotting/identifying relevant entities creates a layer of meta-data on top of the original source input (e.g., Web page or article), which subsequently allows for disambiguation of the various spotted entities. In addition to this domain-based contextual disambiguation, however, the relevance of the disambiguation is also influenced by an opinion graph, creating a relevant, trending entity dictionary which is ranked according to the activity of the entities within the system 100 and in the Web as a whole. Accordingly, the spotter and disambiguation engine 32B may assist a user 105 in expressing opinions on topics expressed in an article or page (e.g., Web page) that the user 105 is reading, importing statistics about entities and opinions to improve the background relevance statistics for the system 100 (e.g., the relevance of entities and opinion words generally in the world at a given time, rather than specific to a particular user 105 or context of the opinion), and automatically creating collections of entities within entity dictionary database 32C based on spotting entities from the Web (e.g., news streams).

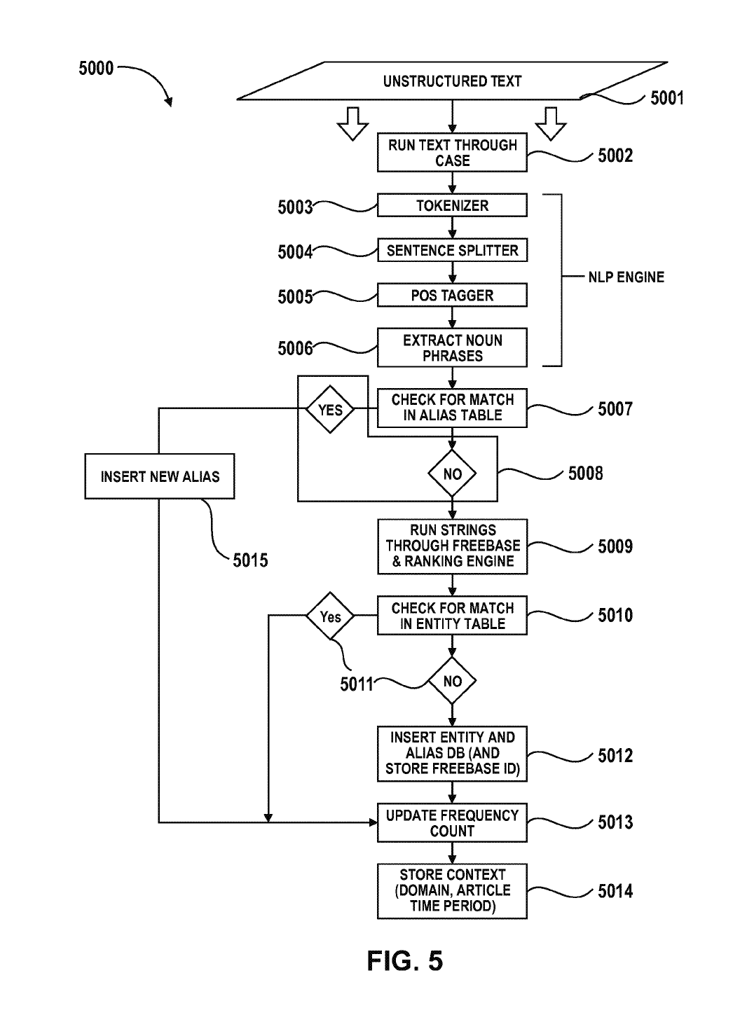

Similar analysis may also be performed on content that is associated with a user 105 (e.g., data spotted using a bookmarklet tool or shared in a Twitter® “tweet”). In addition to text content described above, content 301B may further include data extracted from the group consisting of machine readable tags, metadata, images, external data APIs, and combinations thereof. FIG. 5 depicts an example topic spotting process 5000 for an unstructured input data 301.

In FIG. 5, unstructured input data 301 (start block 5001) is first processed through a “readability” style tool (e.g., CASE) to detect identifying data (e.g., main title, description, author, and so on) for the input 301 (action block 5002). The input data 301 is then run through a natural language processing (NLP) engine to extract relevant portions. Similar to process 4000, unstructured input data 301 is tokenized (action block 5003) and lemmatized (action block 5004) to map variant word forms to a structured lexicon. In conjunction, server 103 identifies key verbs, adjectives, and the entities to which they apply using a POS tagger (action block 5005). Once tagged, the identified entities (e.g., noun phrases) are extracted to spot existing topics in server 103 (action block 5006). Server 103 run queries for each entity against entity dictionary database 32C for any matching aliases of the identified entity (action block 5007). Aliases represent the different forms of an entity object word to facilitate searching or entity spotting (e.g., “soccer” may have “football” as an alias). For any matches (decision block 5008), a new alias reflecting the current entity is stored in database 32C (action block 5015) and a frequency of use for the entity is updated (action block 5013). Unmatched aliases (decision block 5008) are then searched for in alternative database, accessible over data network 101 (e.g., Freebase) (action block 5009). If any matches are found in the alternative database (decision block 5011), the frequency of use for the entity is updated (action block 5013); otherwise, a new entry is created in both the alternative database and database 32C (action block 5012). The identifying information extracted in action block 5002 is similarly stored with the entity (end block 5014).

Once the topics are spotted in process 5000, server 103 may optionally disambiguate topics using disambiguation engine 32B based on the detected domain or category that the input data belongs to. Specifically, to detect the domain or category, the entities from the entire page are ranked in order of relevance for the article, which will be further discussed below. As previously mentioned, disambiguation results are enhanced over time based on continual feedback of relevant topics/domains.

After the input data 301 is translated into a unifying, structured model, nodes extracted from this model may be inserted into database 302B within the core service engine 302. As discussed, these opinion structures may correspond to a controlled natural language, creating a framework and a vocabulary for opinion analysis. In one embodiment of opinion analysis, capturing the contextual and semantic data surrounding an opinion enables the server 103 to populate and navigate an opinion graph. An opinion graph is a network of entities connected by subjective statements. This opinion graph may include the mapping to similarly related topics on the Web, thereby overlaying the developing structured Web of entities, such as from Linked Open Data. The Linked Open Data project refers to a set of well-known best practices for publishing and connecting structured data on the Web integrating cloud computing.

The opinion graph can be advantageously explored from the perspective of any node within it, including: user 105, function, entity, sentiment, context, and intensity. In one embodiment, the opinion graph contains three sub-graphs: (1) a social graph containing relationships between users 105 (e.g., friend-of-a-friend); (2) a function graph containing links between related words; and (3) an entity graph containing semantic relationships between entities and links into the Linked Open Data cloud. Opinion graph 600 provides the additional advantage of directional relationships between users 105 and entities (e.g., an opinion is applied towards an entity). Defining relationships in this way enables facilitated analysis of the opinion (e.g., clustering similar users and so on). A sample opinion graph 600 in accordance with at least one embodiment of the disclosure is illustrated in FIG. 6.

As shown, opinion graph 600 (i.e., for structured opinion “Helen:love:Barack Obama”) contains three sub-graphs including social graph 601, function graph 602, and entity graph 603. Social graph 601 is a social network derived from the asynchronous relationship created when users 105 “follow” or “subscribe to” other users 105 within system 100. When a user 105 joins the system 100, they also have the option to draw/import relationships from various social networking platforms. Examples of known social networking platforms include, but are not limited to, Facebook®, Twitter®, LinkedIn®, and MySpace®. FIG. 6 depicts the social graph for a user 105 having an alias “Helen.”

Function graph 602 is an internal lexicon composed of a rich clustering of words in semantic categories. This is linked to a lexical database (e.g., WordNet), which provides connections between the functions (e.g., “love”) and equivalents in other languages. Functions and their equivalents provide a semantic clustering for enabling aggregation of opinions. Each function is stored in database 302B and marked with a polarity and intensity score as described above (where applicable).

Entity graph 603 diagrams the relationship between the extracted entity of which the opinion applies (e.g., “Obama”). Each entity is connected by virtue of the opinions expressed about them. As previously mentioned, entities are uniquely referenced in server 103 and linked to an equivalent entity in a well known database, accessible over data network 101 (e.g., Freebase). This provides access to rich semantic links between objects in the Linked Open Data graph and may be constantly updated. In addition to structural relationships, entities are categorized such that, for example, the spouse, location of birth, or occupation of a given entity can be shown. Entity graph 603 not only structurally links “Obama” to an opinion reflecting “love,” but also categorizes Obama based on occupation and spouse. These relationships may be exploited in order to fuel a suggestions engine and add to relevance calculations.

The entity graph 603 may also reflect trending topics pulled from the Web. An RSS aggregator 32A provides disambiguation engine 32B with topics pulled from the Web (e.g., RSS feeds). The engine 32B statistically ranks entities per domain to provide a base relevance for particular disambiguation of a given entity, thereby allowing isolation of trending groups of entities. Analysis of the data drawn from the RSS aggregator 32A enables users to explore collections of entities that are derived from both queries into the entity graph and the statistical analysis from RSS aggregator 32A. For example, a collection of entities might include “books currently trending in London” or “most popular people in politics.” Ultimately, users 105 may generate collections by framing any query into the opinion graph (e.g., “most hotly debated movies”).

Because input data 301 includes a broad scope of opinions from multiple contexts and networks described above, server 103 is configured to aggregate similar opinions across multiple platforms for an accurate and comprehensive opinion summary. Users 105 can publish opinion structures and associated data out to any network, increasing the scope of system 100 growth. The community of users 105 collected around a similar idea is known as a “cosm,” and includes all the users 105 who have contributed to that opinion. When a user 105 makes an opinion, they enter an implicit group together with other members of that “cosm.” Opinion graph 600 illustrates a “macro-cosm” 604, which is a clustering of all the similar attitudes towards a given entity (e.g., the users 105 that all love Obama), or of all the similar types of objects/entities. Conversely, “micro-cosms” can be shown, which consist of all the particular reasons that have been expressed for a given opinion. Users 105 may also elect to share a particular “cosm” to selected users 105, or users 105 within another “cosm,” to structurally link unrelated opinions. Over time, “cosm networks” are created that contain users 105 with broadly similar ideas, from which other social communities are formed. Accordingly, server 103 provides the additional advantage of graphically analyzing and navigating large amounts of opinion data from different platforms easily.

For example, any organization, political party, group, or individual can form “cosm networks” to broaden their support base or publicize their campaign to specific targeted interest groups. Other users 105 can cluster around particular ideas and take collective or individual action on the basis of an expressed opinion. Advertisers similarly can create or select specific “cosm networks” based on opinions regarding their own products, services, areas of interests, and so on to communicate directly with an audience group having a specific, similar interest. The audience group can be further filtered according to the geographic location of individual members of the audience group, specific opinions, or demographic information (e.g., age or gender). In this way, an advertiser can choose to show advertisements to, for instance, all members of an audience group who have stated positive opinions on skiing and are based in the UK. In one embodiment, users 105 must choose to take part in a “cosm network.”

As each opinion is aggregated into “cosms,” server 103 further is configured to notify (e.g., via e-mail, mobile, application, and so on) the respective users 105, whose opinions were aggregated, that their opinions have been counted and published. In one embodiment, this notification includes a link to the location of the published aggregate opinion to allow the user to view the relative impact of their submitted opinion. This constant feedback to the user 105, therefore, provides the advantage of attracting new users to a new location (e.g., Web page) for both reinforcing that the opinion is heard and establishing a new, relevant audience.

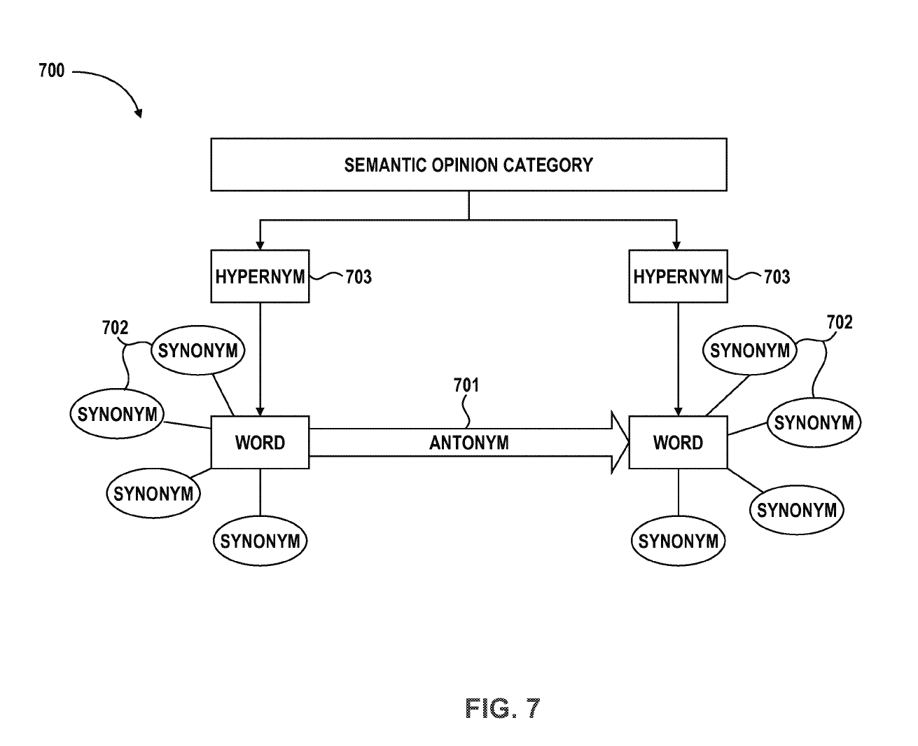

In order to compute opinion similarity—such as, to generate a “cosm,” server 103 may draw on both a linguistic understanding of opinion words and statistical analysis of the usage patterns stored at server 103 (e.g., database 302B or 32C). Words stored at server 103 are mapped to a lexical database (e.g., WordNet) to provide semantic relationships between words. For example, FIG. 7 depicts aspects of example semantic relationships 700 in accordance with at least one embodiment of the disclosure. Semantic relationships 700 include antonyms 701, synonyms 702, hypernyms 703, hyponyms (not shown), and related forms of specific words. Furthermore, mapping to a lexical database also provides links to equivalents in other languages for overcoming language limitations. Server 103 may map emotive words along a spectrum of affect, which allows users to clearly see the range of opinions within a particular “macro-cosm.” Word usage is monitored over time in order for server 103 to statistically offer appropriate suggested opinion words for a given entity, as previously discussed for input data 301, or in response to another opinion word.

Server 103 can also learn based on user 105 activity. If an unknown word is repeatedly used in reaction to, or conjunction with, another cluster of words, server 103 may infer a strong link between the words, which may be a basis for aggregation. In this way, new words are continually adapted into the server 103 database (e.g., database 302B, 32C), and the internal lexicon may evolve as organically as natural language trends outside of system 100.

In an alternative embodiment, the server 103 can improve the accuracy of the clusters of words and semantic relationships using statistical techniques based on the co-occurrence of words within opinion objects. For example, word A and word B commonly are used together (e.g., by users forming opinions). If word A and word C similarly are used together, server 103 can infer a relationship between words B and C. However, any similar statistical technique may be used for clustering and aggregation, and are well known in the fields of machine learning and data mining. It should similarly be understood to those of ordinary skill that this process can apply to both user-submitted opinion data to server 103 and derived opinion data from corpuses of text and Web pages, for example, representing larger discussions over longer periods of time.

In yet another alternative embodiment, deriving relationships between words and sentiment/polarity scoring may include manually ranking and processing sample sets. A plurality of manual ranking scores is averaged to account for “wisdom of crowds.” To facilitate this process, well known human intelligence in Web service solutions, such as Mechanical Turk from Amazon®, may be used.

Opinion words stored in the database 302B, 32C are also closely tied to suggested actions which arise from particular “cosms.” Users 105 are able to suggest actions which relate to opinions, enabling users 105 to act upon the ideas stimulated by and expressed within the system. In one example, user 105 may be an organization or company, who could “sponsor” an action which would be suggested to particular “cosms.” Server 103 statistically analyzes words usage patterns within and outside the server 1033 to indicate potential actions which can be tied to an opinion.

In an alternative embodiment, once the structured opinion is ranked—based on domain recognition (i.e., via disambiguation engine 32B)—and graphed (e.g., FIG. 5), server 103 is configured to suggest/recommend appropriate content and opinions to specific users 105. A relevance ranking also allows users 105 to search for entities, opinions, opinion keywords, and other users 105 against the structured opinions. Specifically, a relevance engine 303 is included in server 103 to calculate the relevance of particular words and entities (e.g., nodes of the graph) to each other, and to a specific user 105. Relevance engine 303 inspects each unifying, structured node that was inserted into database 302B, 32C for its general relevance, or specific relevance to the active users 105 in system 100. This process can be applied to entities, cosms, opinions, comments, users 105, media, content, and so on. User 105 input may also customize relevance parameters for specific domains or applications.

In one embodiment, relevance is calculated per user 105 on the basis of the activity of their specific network. For example, relevance may reflect a user's 105 ideas based on the creation of “cosm networks” above. Recommendations based on this type of relevance typically are centered on a user's 105 social graph 601. As discussed above, users 105 may also draw/import relationships from various social networking platforms, which ultimately enables users 105 to receive recommendations from multiple social networking platforms in a centralized location.

For every user 105 in system 100, relevance engine 303 isolates the nodes within their opinion graph 600 to calculate individual scores based on an n-dimensional matrix, where each dimension represent a different relevance parameter. These parameters include, but are not limited to, type/domain of the entity, “SocRank” (i.e., weight in the social graph based on opinions made by a user 105's social network), “CosmRank” (i.e., weight in the opinion graph based on opinions that the user has made in the past), “PageRank” (i.e., based on matching the text in an article opined on with descriptions of an entity—derived from manual input or third-party database—to create text-based representations of user opinions), “GeoSpatial Rank” (i.e., based on geographical location where opinions are made), “Trend Rank” (i.e., ranking opinion/entity nodes from followers and influencers higher than other opinions), “Tracking Rank” (i.e., ranking specific users, entities, and categories higher when a user optionally follows/tracks it), ranking related entities and categories, and “opinion activity rank” (i.e., higher ranking reflecting greater activity, such as responses). Users' 105 input may also be used to specify ranking parameters to server 103. In a preferred embodiment, weight is assigned to each of the aforementioned parameters on a numerical scale from 1-10.

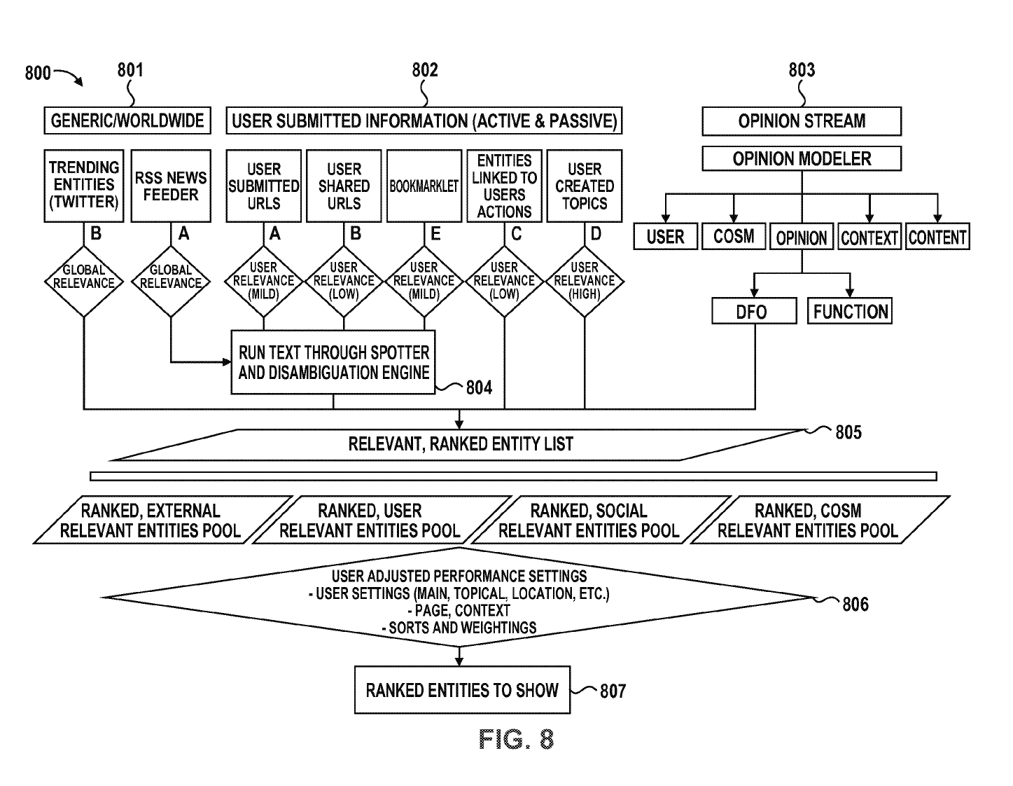

In one embodiment, relevance engine 303 calculates relevance scores as an offline process at the point of user 105 interaction. Any number of scores can be added for new parameters, such as, for example, data based on new relationships or temporal information. FIG. 8 illustrates various points of user 105 interaction when offline-processing 800 of relevance calculations are added to the ranking of a particular node in an opinion graph 600.

In an alternative embodiment, relevance engine 303 retrieves relevant nodes from the opinion graph 600 immediately after user 105 submits a new opinion. These nodes are aggregated to be presented as “opinion results” to user 105. “Opinion results” illustrates to the user many connections and interesting paths to follow in the opinion network as a direct result of the currently submitted opinion. These connections and paths may include, but are not limited to, relevant entities, users, opinions, actions, articles, or combinations thereof.

As discussed, electronic input data 301 includes generic/worldwide topics 801, user submitted information 802, and various opinion streams 803. Through analysis of articles 801A in the news/throughout the web (e.g., via a RSS news feeder), processing 800 spots entities from the text, populates entity dictionary database 32C, and ranks each entity according to the degree to which the entity is trending globally, and per domain (e.g., using spotter and disambiguation engine 32B). Similarly, server 103 parses and disambiguates trending entities 801B of a generic/worldwide type (e.g., trending Twitter® topics) to calculate a ranking score based on global trends.

Relevance calculations also occur for user 105 submitted information 802 including: user submitted URLs 802A (i.e., where a user 105 has directly indicated their interest in a particular site); user-shared URLs 802B (i.e., where a user 105 shares a link with other users 105 of their social network); user's 105 activity 803C pulled from their other accounts from the Web (e.g., a played track on Last.fm, a book bought on Amazon.com®, or a movie from Netflix®). Server 103 matches these entities to generate background relevance data.

When a user 105 actively creates an entity 802D within server 103, server 103 is also configured to generate related entities that may be of relevance to the user 105, such as by semantic relationships. Users 105 may also activate a bookmarklet 802E on an article or post for server 103 to record the context (i.e., domain name) and add a ranking accordingly. Articles 801A, user submitted URLs 802A, user-shared URLs 802B, and bookmarklet 802E articles are run through spotter and disambiguation engine 32B (action block 704) to identify the relevant entity and disambiguate based on the context.

Furthermore, FIG. 8 depicts relevance calculations obtained during opinion stream input 803, which includes topics on which a user has emoted, topics and opinions trending in a user's 105 social network, and topics and opinions trending in a user's 104 “cosm” network. Thus, the relevance engine 303 not only generates suggestions within a single Web site, but also calculates inferred interests and relevant entities of a particular type based on the generated opinion graph 600. At each point of user 105 interaction, ranking calculations create a full matrix 805 of scores that include the appropriate metadata surrounding nodes in opinion graph 600 (e.g., location and timestamp). This matrix 805 can be shown to the users 105 on their user devices 105A, 105B, 105C, and 105N for further review to modify calculated relevance scores for the various processed entities (action block 806). Any modification to relevance scores provides feedback to server 103 for adapting to a user's 105 specific preferences. For example, if a user 105 chooses to ignore or “bin” and entity which appears in his suggested topics/opinions, the server 103 draws upon related data to lower the ranking of similarly suggested/ranked items. Accordingly, only personally, directionally relevant entities/opinions/topics 807 are shown to a specific user 105. By capturing opinions and data in this way, server 103 facilitates human, opinion-driven relevance on top of a structured Web.

Based on the calculated relevance scores, users 105 may also browse and discover new relevant content, not yet suggested. When users 105 make opinions in the context of an article, for example, server 103 may provide the user 105 other sources (e.g., articles and other contexts) where the opinion has been made for uniquely relevant content suggestions. Conversely, users 105 can similarly browse other opinions that a particular piece of content has prompted.

In one embodiment, once a user 105 views specific information or opinions about an entity, associated and related entities that may also be of interest to the user may be displayed (i.e., based on relevance score). Accordingly, the association of one entity to another may come from multiple sources, such as the text matching described above. However, the association of two or more entities may be compiled from manually curated associations (e.g., a curator or an administrative panel). Some associations of two or more entities are formed based on context of a previously submitted opinion, which formed a bidirectional relationship between two or more entities (e.g., a news article opinion on the topic “football” would form a bidirectional relationship between “football” and the article). Associations between entities may be formed in response to an opinion on a different topic, nonetheless, forming a bidirectional relationship (e.g., an opinion on “cake” receiving a response of an opinion that “donuts” are “better” would create a bidirectional relationship between “donuts” and “cake”). These associations are scored and ranked based on popularity, semantics, and so on. In one embodiment, associations may be reflected in entity graph 603.

Once the input data 301 is translated to a unifying, structured model, graphed, and ranked according to relevance scores, an opinion network is generated such that users 105 can interact with a large volume of opinion data. Users 105 are able to better understand what a community is saying about a specific entity, product, brand, or issue from multiple platforms across the Web. More specifically, users 105 have the option for understanding the opinion/recommendation from like-minded users with similar interests, which may increase the propensity to make purchases and promote consumer transactions. Capturing structured, rich opinion data allows, as another example, companies to discover specific opinions about their products or brands with associated reasons that are mapped and organized at various levels of aggregation. Therefore, both individual opinion-givers and trends can be identified, including key influencers and opinion leaders, while users and companies can engage directly with supporters, customers, and critics.

In one embodiment, this data can be shown to the users 105 on their user devices 105A, 105B, 105C, and 105N. Specifically, users 105 can access Web services 102 from their user devices 105A, 105B, 105C, and 105N. Web services 102 may include various Web sites such as social networking platforms, media pages, blogs, and electronic commerce (“e-commerce”) sites. However, processed opinion data, such as by opinion capturing server 103, enables users 105 to experience Web services 102 as opinion enhanced Web services 104. Users 105 request access to opinion enhanced Web services 104 (e.g., via Web browser) to view opinion graphs 600, browse social networks, receive recommended opinions and products (e.g., targeted advertising), analyze cognitive/linguistic data, and so on.

In addition to browsing a rich opinion network, opinion enhanced Web services 104 provide a discourse model to trace propositions, justifications, responses, resolutions, and actions taken in response to an opinion. As a specific example, opinions can be presented in the form of a debate. A debate is identified when there are at least a predefined (i.e., configurable) threshold number of opinions with respect to a particular entity that uses function words from two or more opposing synets (e.g., synsets with opposing meanings). The different sides of the debate may be named using the most frequently used opinion word from each sysnet associated with the entity. Users 105 with opinions that contribute to the identified debate may be notified of the debate.

Users 105 are encouraged to interact with opinion enhanced Web services 104 (e.g., participating in interactive flows of the opinion network) for promoting growth of system 100. In one embodiment, users 105 can invite friends and other users to join their social network and participate in one or more opinion flows. For example, upon seeing an opinion, a user 105 can elect to respond to the opinion in at least three ways: (1) agree/disagree; (2) ask “why?” and (3) comment. If a user 105 chooses to agree or disagree, an option is also provided to generate a new opinion. The new opinion maintains a link (e.g., agreement/disagreement relationship stored in database 302B and reflected in opinion graph 600, for example) with the original opinion. For the original opinion word, the controlled natural language interface, discussed above, prompts synonyms (i.e., in the case of agreement), antonyms (i.e., in the case of disagreement), or free-form opinion guidance (i.e., in the case of responding with “ask why?”) to assist the user 105 in creating the structured input for their new opinion. The chosen opinion word may be used to clarify the confidence of the semantic relationship (e.g., synonym/antonym) to the original opinion word. The author of the original opinion is then notified that another user 105 has replied to their opinion.

Similarly, specific opinions may be shared among users 105. For example, user 105A elects to share an opinion or ask for an opinion about a particular entity. User 105A chooses to share the opinion with user 105B. Sharing channels include, but are not limited to, social networking platforms, e-mail, and short message service (“SMS”) communication. A notification is sent to user 105B, for example, via e-mail, SMS communication, push notification to user device 105B, or upon user's 105B subsequent request for opinion enhanced Web services 104. User 105B includes both users registered with server 103 and users who have not registered with server 103. User 105B then follows the notification (e.g., via hyperlink) and server 103 maintains history that user 105A successfully prompted user 105B to access opinion enhanced Web services 104. User 105B can similarly respond to user's 105A opinion in the manner described above.

In order to further incentivize users 105 to interact with an opinion network and enter opinions, users 105 may earn rewards for their participation. These rewards include special achievements, impact scores, and gaining status roles. A user 105 receives achievements whenever they hit a particular milestone. Achievements are intended to encourage users for specific actions. Some examples include: an achievement for being the first user to publish an opinion for a given topic); a “one-sided debate” achievement for a user elaborating on a created opinion without enticing others to participate; a “debate” achievement for users participating in a debate; “opinion count milestones” for various thresholds (e.g., 10, 25, 100, and so on for the number of submitted opinions from a single user); “category milestones” for various opinion thresholds for a specific entity/category; “reason milestones” for generating an opinion that includes responses surpassing various thresholds; a “polarized agreement” achievement when a threshold ratio (e.g., 90%) of the opinions for an entity agree with a user's opinion; a “polarized disagreement” achievement when a threshold ratio (e.g., 10%) of the opinions for an entity agree with the user's opinion; a “thought leader comparison” achievement when a user's opinion disagrees with the opinion of a thought leader, which will be further described below; and a “friend comparison” achievement when a user's opinion disagrees with the opinion of another user within their social graph for a particular entity.

Similarly, impact scores are used to quantify a specific user's influence in the system 100. In one embodiment, points to determine an impact score are accrued as shown in Table 1:

TABLE 1
Example Impact Score Calculation

| Action | Points |
|---|---|
| Receiving agreement with an opinion | 4 |
| Receiving disagreement with an opinion | 3 |
| Receiving a comment on an opinion | 1 |
| Responding to a topic request | 2 |
| Responding to a reason request | 1 |
| Receiving an indirect agreement (e.g., a user | 2 |
| prompting another opinion that is agreed upon) | |
| Receiving an indirect disagreement (e.g., a user | 1 |
| prompting another opinion that is disagreed with) | |
| Receiving a new follower | 1 |
| Registering with server 103 | 5 |

For each action represented in Table 1, the impact score is then the total number of points accrued over a pre-defined time period (e.g., 120 days).

Similar to achievement awards and impact score, individual users 105 can attain “thought leadership” status when their opinion generates the highest number of agreements for that topic. To become a thought leader, the number of agreements for that topic exceeds a minimum threshold (e.g., 5 users) and the thought leader's total impact score exceeds any other user 105 by at least a threshold number of points (e.g. 2 points). In one embodiment, thought leaders are identified—including the thought leader's specific opinion and number of agreements prompted—when any user 105 views the particular entity topic. However, in an alternative embodiment, the top 5 users 105 may appear as thought leaders on a given topic. Identifying a thought leader occurs when there is a threshold number of associated users 105 (e.g., 1 user) that have prompted at least one agreement. Each user 105 is similarly associated with the number of thought leader roles the user holds, the number of agreements the user has prompted, and the number of topics for which they may become thought leaders (e.g., 3 user agreements away).

Similar to “thought leaders,” in an alternative embodiment, server 103 may assign additional roles to specific users 105, which create a unique experience for that type of user 105. These roles include, but are not limited to:

Advocates: These are individuals that rally support and act as an “advocate” for a particular opinion. An advocate role enables other users 105 effectively to add support, weight, or backing to the advocate user on that particular opinion, thereby allowing the advocate user to speak and emote on another user's 105 behalf. Representative can emerge within system 100 and the community can form a democratic support system for specific opinions.

Thought Leaders: Particular users 105 can be thought leaders based on their specific influence within system 100. When a user 105 stimulates another user 105 to give an opinion/change their mind, server 103 rewards that user 105 by giving him greater visibility to other users 105 (e.g., highlighting the user on cosm pages or providing direct rewards, such as badges).

Administrators: Trusted users 105 have the ability to act as administrators to moderate data and behavior in system 100. Administrative duties include moderating disputes and abusive behavior, correcting existing opinions presented about entities or functions, and mapping new words as they emerge (e.g., slang). Administrators may be democratically promoted or rewarded with privileges based on activity in system 100.

Groups: Users 105 may create or join groups gathered around a particular idea, entity, or context. These groups can be led by specific organizations, companies, or individual users. Groups are administrated by the community and server as hubs which stimulate further conversation and action.

Personas: Personas are a type of implicit group formed by virtue of a user's 105 opinions. For example, an opinion profile may demonstrate a user 105 to be Republican, a movie buff, or a dog-lover. These “personas” may also form the basis for an action or query into the system, such as, generating a collection based on the opinions trending amongst a specific political party, or share an action or “cosm” directly with all animal-lovers.

At any given time, server 103 also is configured to communicate globally with all users 105 of server 103. This provides the advantage of providing opinions/messages that relate to all users (e.g., global, philanthropic messages such as flu vaccine notifications), thereby promoting particular causes and educating any user 105. Opinions and reactions of users 105 can be posted dynamically.

In an alternative embodiment, a dashboard widget operates at the input 301 level to provide quick access to opinion enhanced Web services 104 from a user device 105A, 105B, 105C, and 105N. A dashboard is a display intended to show interesting/specific aspects of the opinion network to a particular user 105. The dashboard includes at least one “widget,” which is a contained area of Web or application content for providing various summaries of the opinion network. Widgets are typically moveable or resizable to scale according to the size of a user 105 display or for customizable layouts. The dashboard may appear on a Web page (e.g., opinion enhanced Web services 104 and third-party Web pages from partner owners), a mobile application, electronic public displays, and so on. Additionally, a set of dashboard widgets can be used to show interesting information from the opinion network to a user immediately after making an opinion (e.g., opinion results described above). For example, an electronic article or Web page incorporates scripting code (e.g., JavaScript) for integrating a specific widget. The specific widget is uniquely identified and communicates through an API to process various input opinion data 301. The use of dashboards and widgets are well understood and appreciated by those of ordinary skill in the art. A dashboard widget allows users 105 to seamlessly make opinions, such as through opinion enhanced Web services 104, view opinions, explore user profiles, and browse various topics.

For example, dashboard widgets may be used to display a polar topic category. A category is defined as a semantic grouping of entities (e.g., presidents, public speakers, and people). To entice users 105 to make opinions on topics in a given category which have prompted highly positive or negative opinions, a dashboard widget may be used to show the topic in a given category (e.g., “ridiculous politicians”) which has the most average positive or negative opinions. For a given category, the dashboard widget can show a cluster of all entities in that category with a similar overall sentiment.

In another example, a dashboard widget may be used for a single function, such as for enabling a user to submit an opinion without leaving a Web page. For example, an aggregated opinion relating to an article/Web page/product may be placed as a widget next to the respective entity/topic (e.g., “Overstated” button next to an article link). Users 105 click on the widget to automate their opinion to the article.

Dashboard widgets are effective not only for users providing opinions but also for publishers and bloggers who wish to aggregate opinions and responses to their published content. For example, a publisher widget works at the article level (i.e., the published content) and creates a layer of metadata on top of the published text. The publisher widget is integrated into the published text (i.e., script within the page source) and includes a unique identification code. For each opinion or comment on the article, the URL of the published text is communicated to server 103 along with the unique identification code of the publisher widget. Once server 103 receives the data, the spotter and disambiguation engine 32B determines relevant topics/entities from the published text article (e.g., using natural language processing and text-mining described above, while ignoring advertisements). Each relevant topic/entity is linked to any relevant topics/entities, such as, from a third-party database (e.g., Freebase), thereby connecting the topic/entity to similar references for additional information. As a community of readers, as well as the author of the article, read the article and form opinions, the publisher widget is also configured to retrieve the entity list from database 302B for creating aggregate views. Accordingly, publisher widgets provide the additional advantage for gaining insight about the context of the article, relative opinions, and the profiles for other readers and authors.

Dashboard widgets also may be used for, but not exclusively:
Providing a natural language description (e.g., or graphical representation) of a specific user 105 based on the user's 105 submitted opinions. Server 103 determines categories where a user has made opinions that vary from the norm and generates descriptive labels for each (e.g., “Dan is a business person, and a foodie. Dan has no opinions yet on Product lines or Ad network verticals.”);
Showing the top trending debates in a given category/topic to encourage user 105 input. The top trending debate is determined by counting opinions with a decay to emphasize newer opinions higher than old ones. For each category/topic, the strongest polar words are used to describe the debate (e.g., “Debates in London:amazing/freezing”);
Viewing topics with highly polarized opinions. A predefined number of the most sentimental topics (i.e., net positive or negative opinion) are chosen (e.g., “Smoking has generated a strong negative opinion”);
Viewing the top debates per entity, wherein the decayed frequency of the same positive and negative words are determined globally (or for a specific category) to view the topics with the highest use of those words (e.g., “thought provoking vs. scary: (1) sports stars at risk; (2) U.S. Customs; and (3) legislation);
Viewing most hotly debated topics within a particular category. For a given category, entities are ordered by the standard deviation of the sentiment scores of their opinions (e.g., “Lyricists: Paul Simon or Adele”);
Viewing most reacted to opinions within a recent timeframe. The score for an opinion is calculated by counting the number of responses and factoring in decay over time (e.g., “iPhone” or “birth control”);
Showing the most commonly used words from a particular user, per category. For a particular user, the most frequently used word is selected within the category having the most submitted opinions (e.g., “Organization topics frequently using ‘awesome:’Pixar and Arsenal F.C.”);
Showcasing topics where users hold both positive and negative opinions (e.g., “Foie gras is delicious yet inhumane”);
Browsing a group of similar users to provide a suggestion topic. Similarity is calculated using overlap of opined-on topics between users of a group and average sentiment score. Suggestions are provided where a minority of the group has not made an opinion (e.g., “User A—38 agreements, User B—24 agreements, and User C—13 agreements: suggest opinion about soul and dance exchange”);
Showing a set of topics where users have an extreme set of opinions. Words with a similar intent (e.g., love and adore) are clustered to select the top entity receiving the specific word (e.g., “most insulted celebrities”);
Highlighting interesting words currently used. Recently used words are used to determine the least used word from the group (e.g., “gracious last used about Ernest Borgine”);
Viewing interesting spikes of an unusual number of occurrences of a specific opinion word. An unusual number of occurrences is calculated by comparing the total number of times the word has been used for an entity with the inverse of times the word is used overall (e.g., “Hurt Locker is more heavy than No Country for Old Men”);
Showing a user's 105 similarity to another user 105. For topics where both users have made an opinion, similarity score is determined based on the similarity of opinions (e.g., “User C agrees with you on 581 out of 903 topics”); and
Highlighting users 105 who have dissenting opinions. For each entity, a user is determined who has the largest difference in sentiment score compared to the average of the users making an opinion on the specific topic (e.g., “User B's opinion is against the grain in arts—get to know why.”).

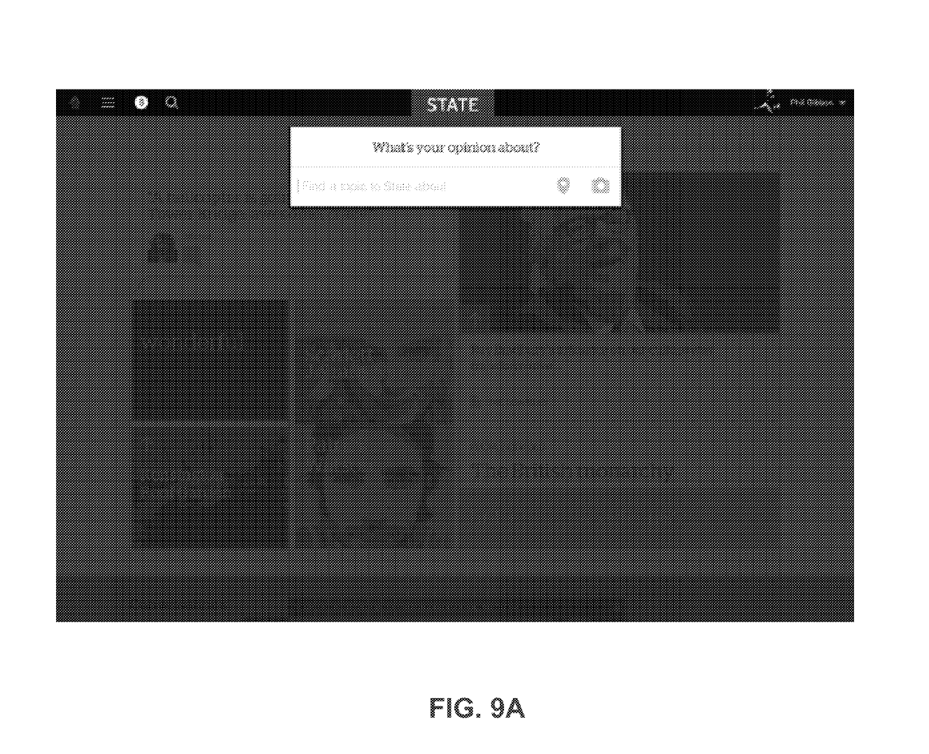

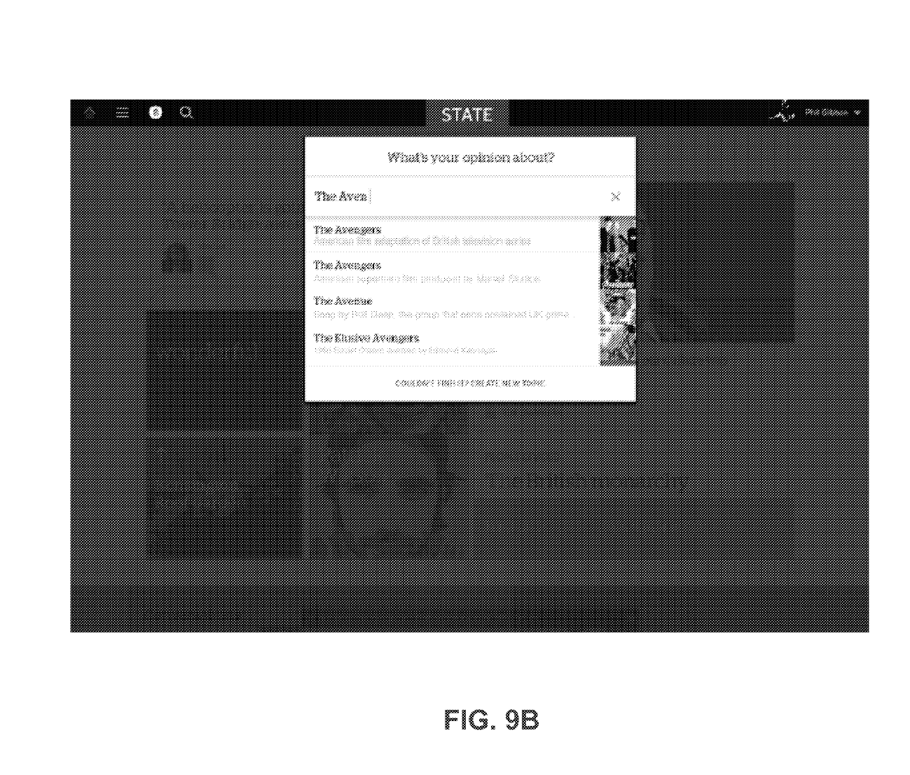

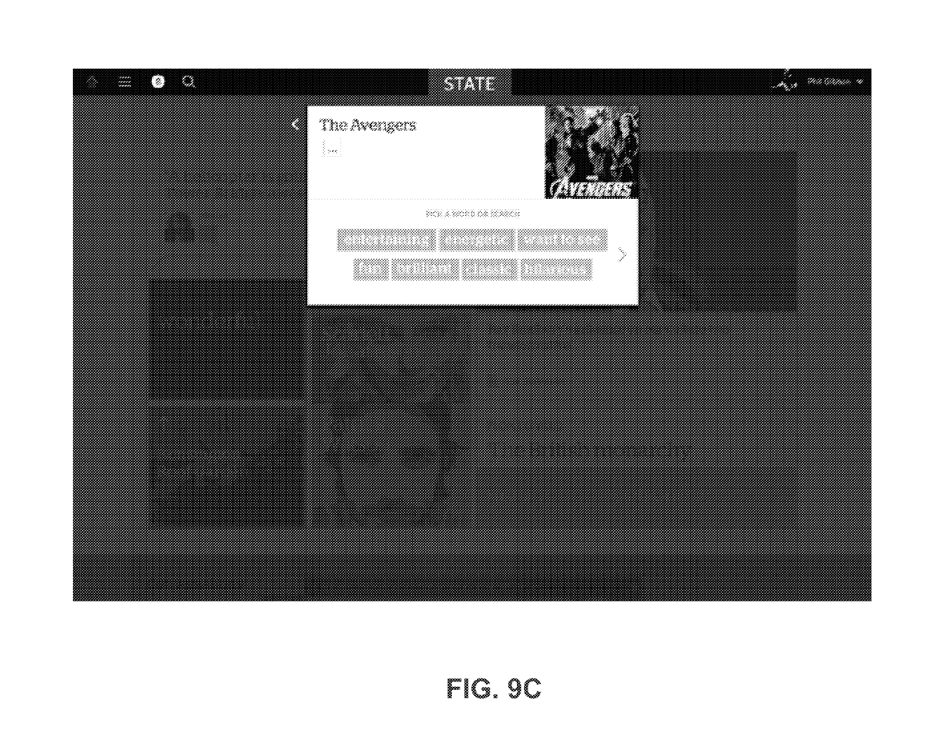

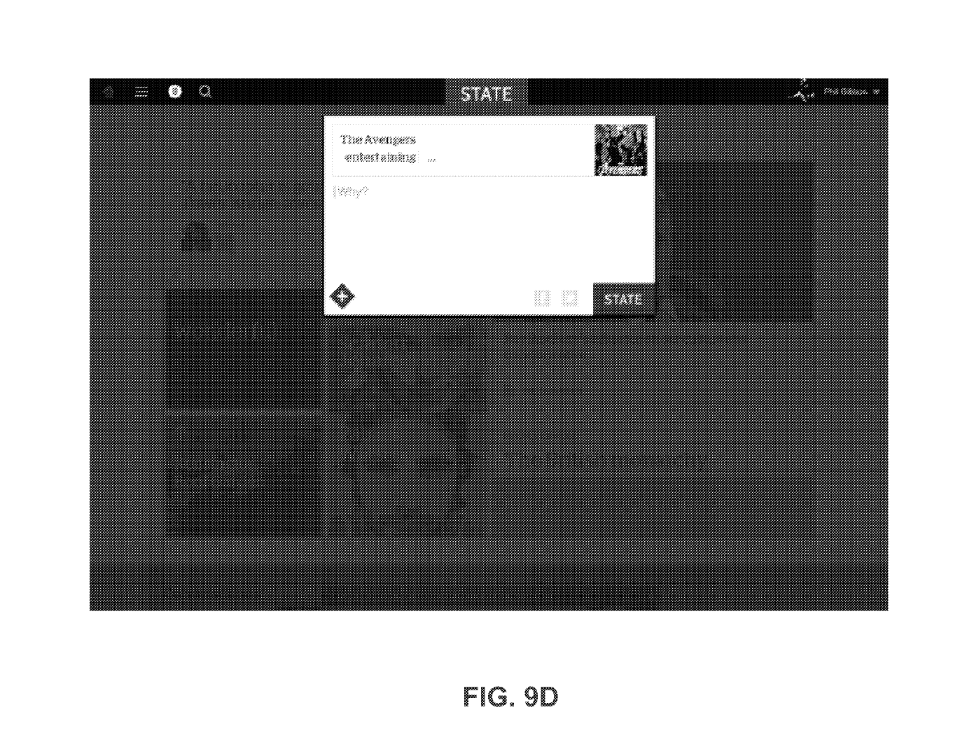

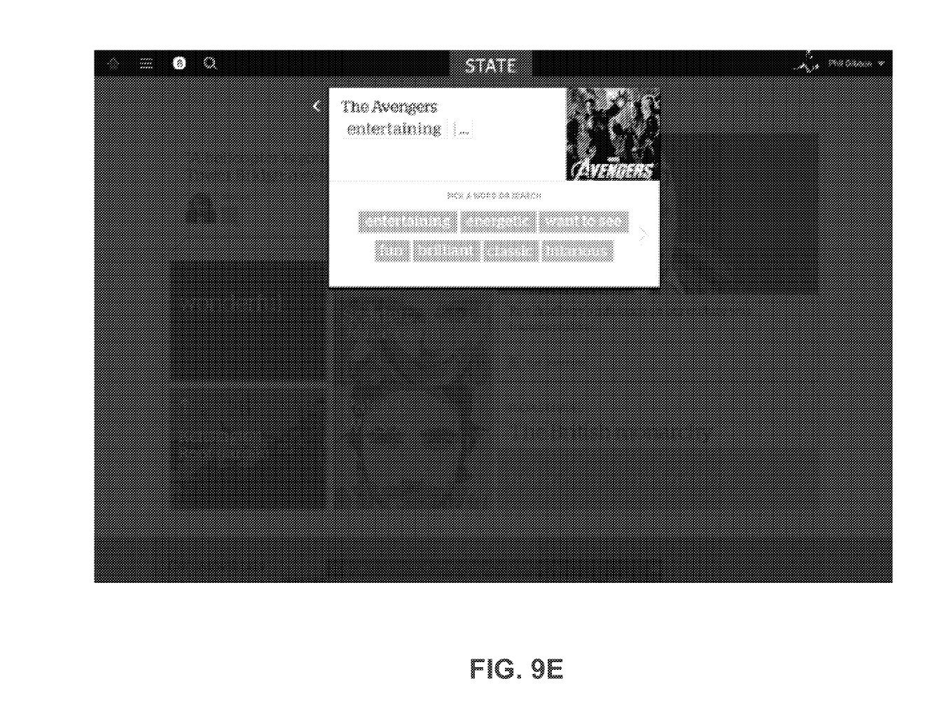

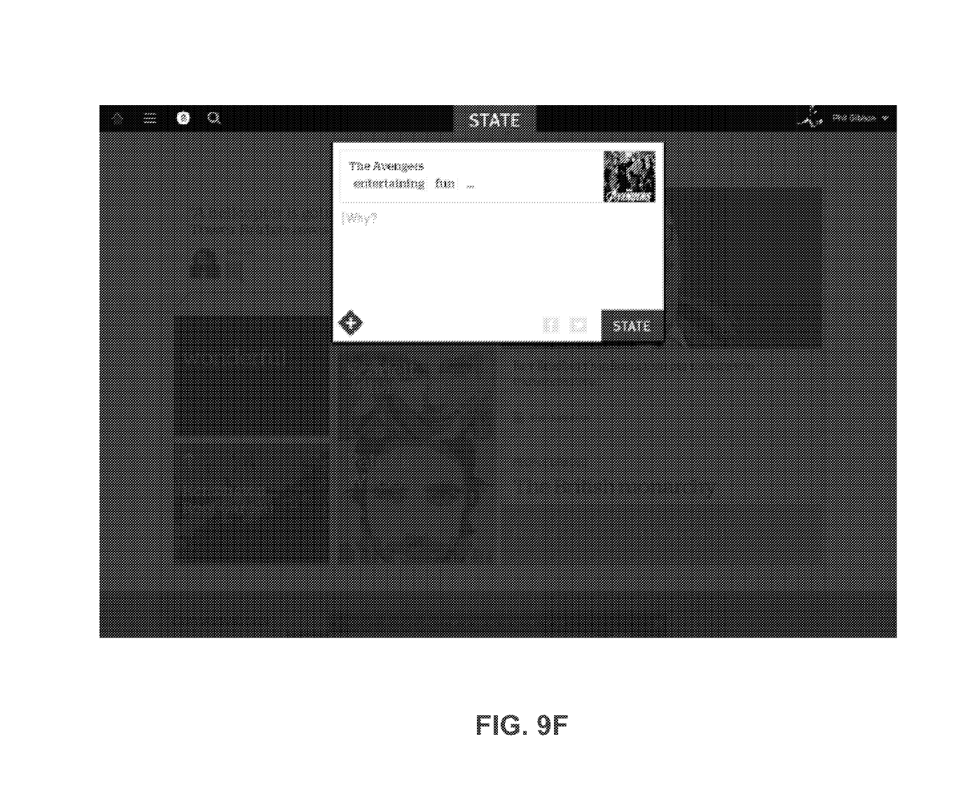

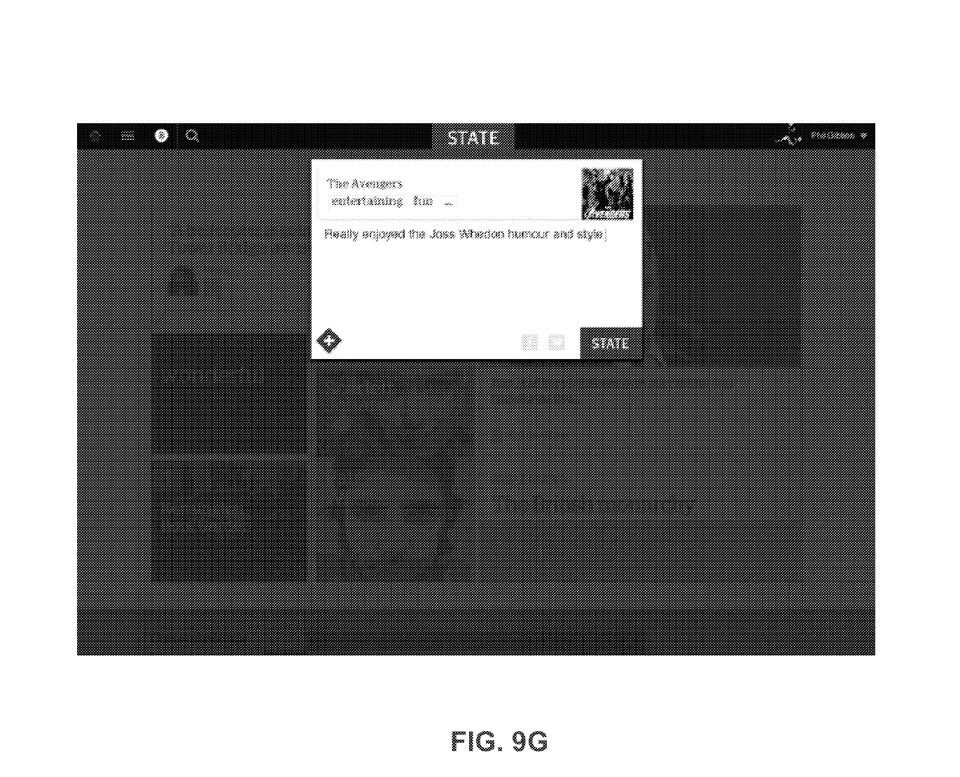

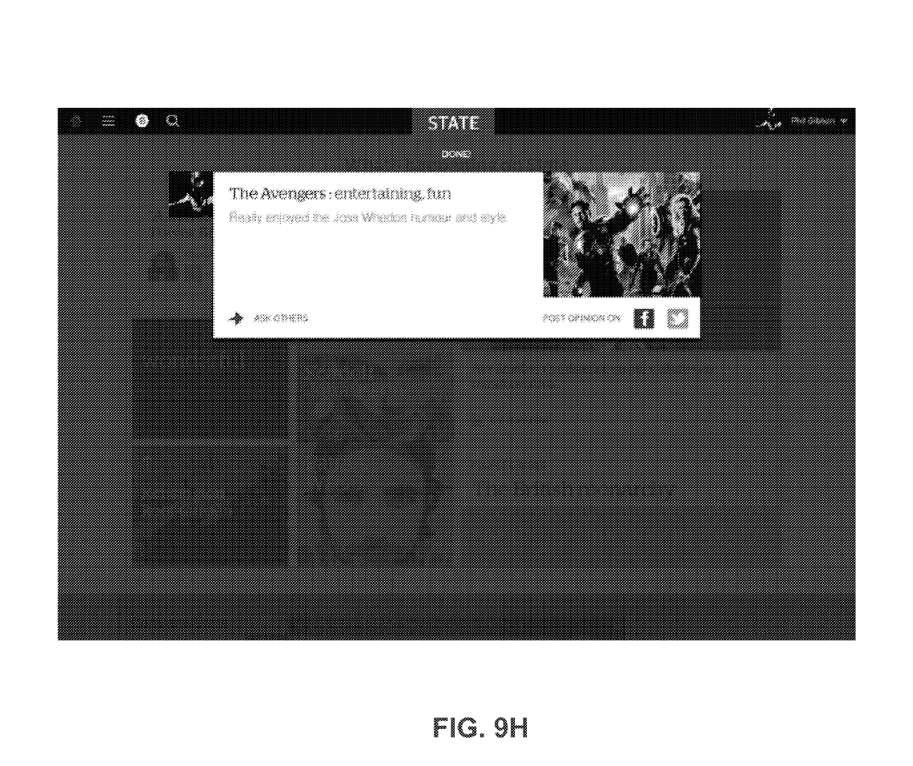

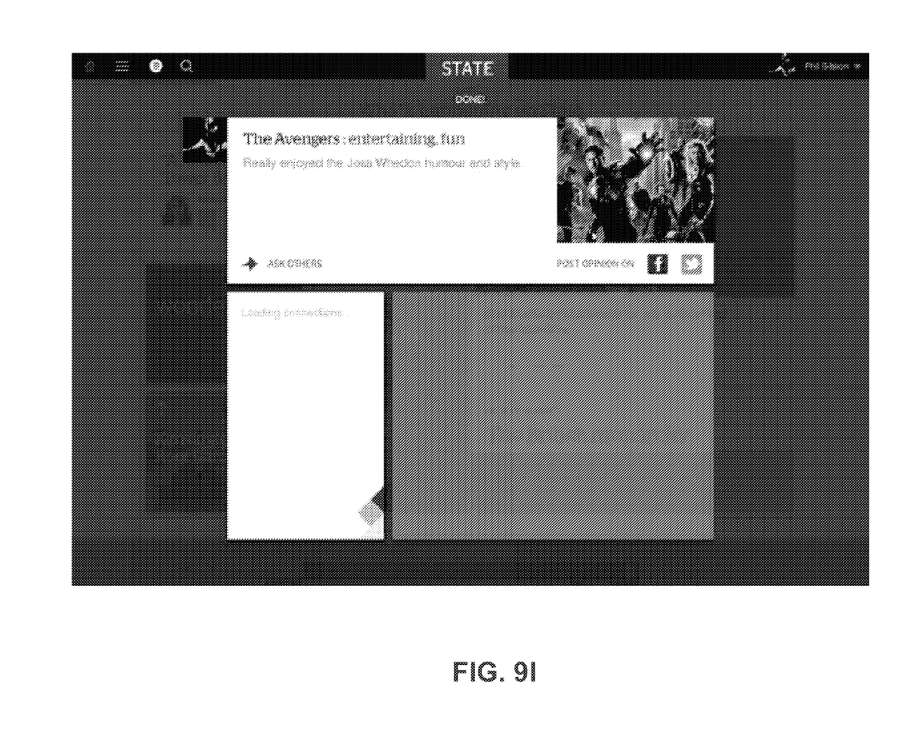

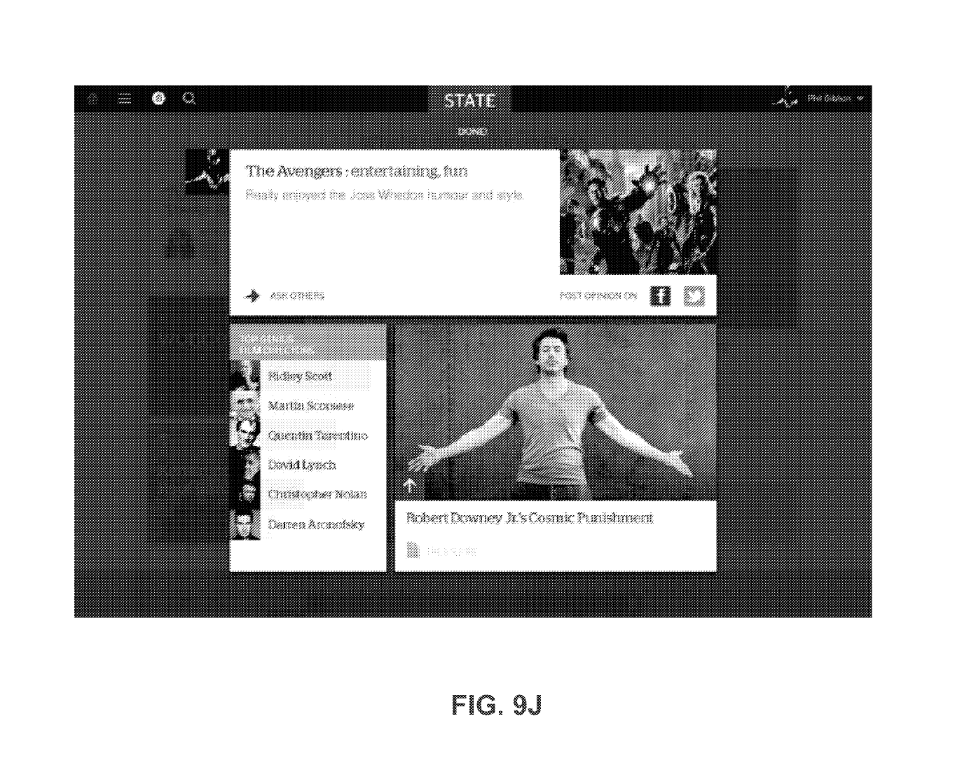

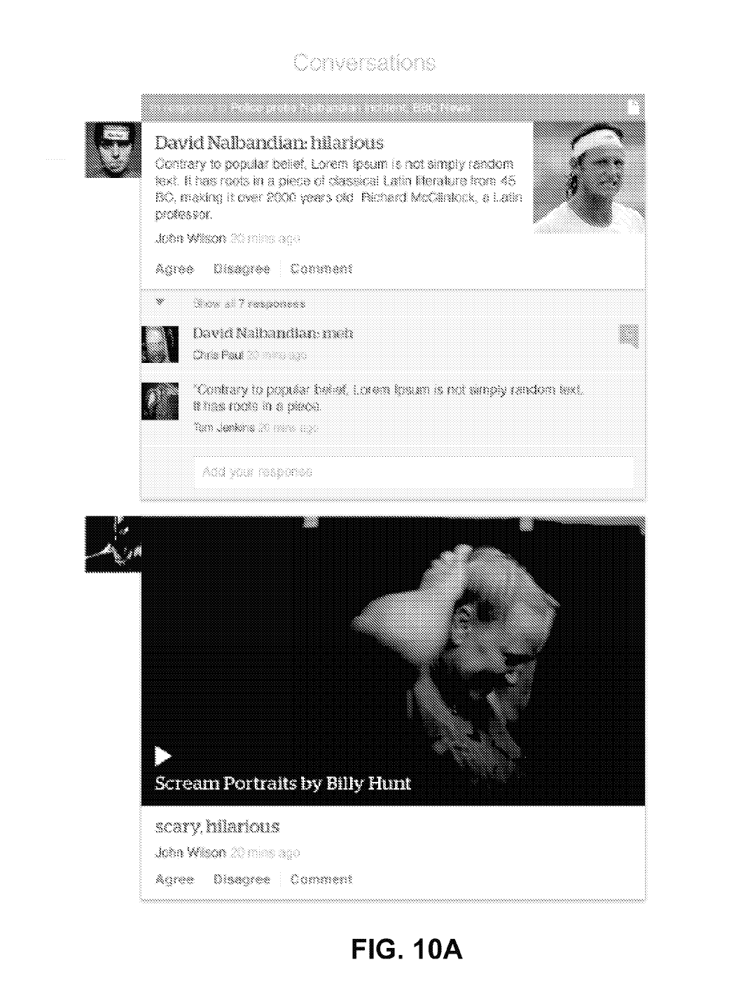

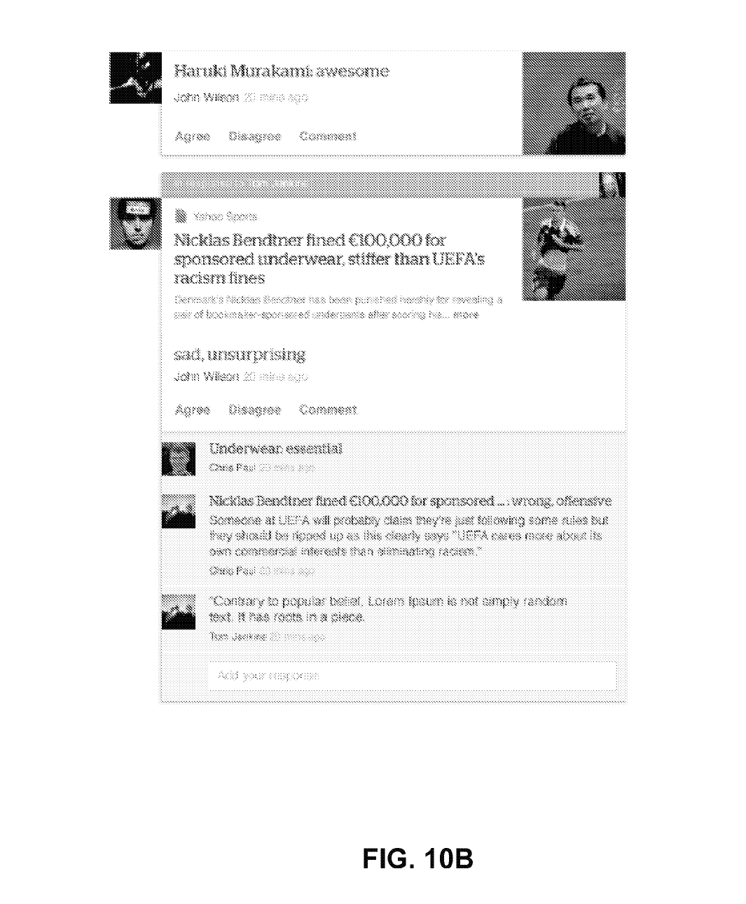

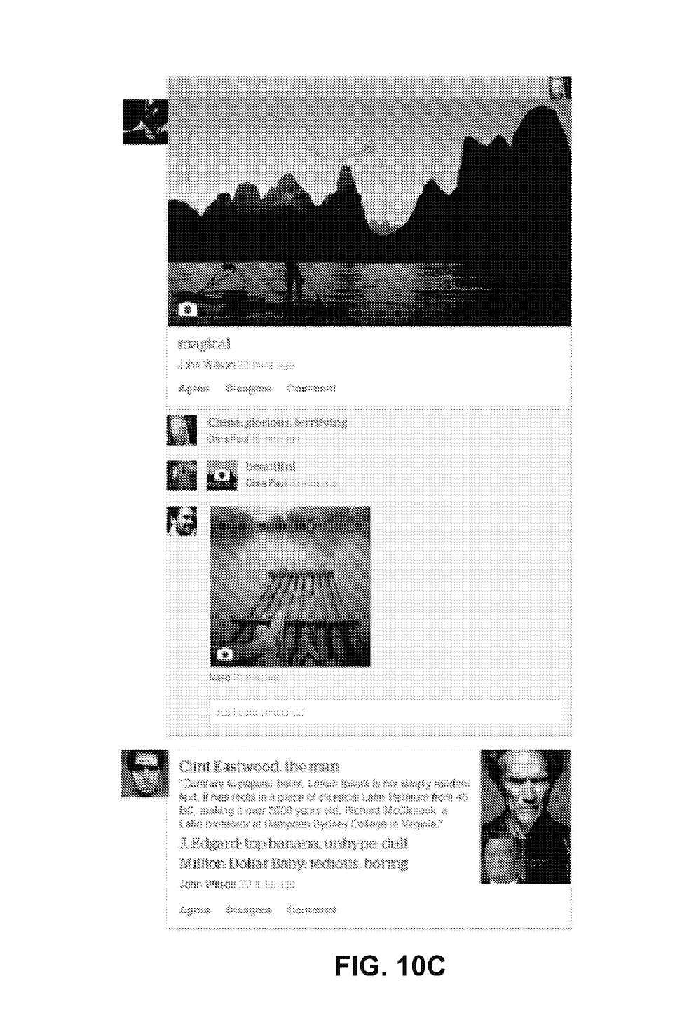

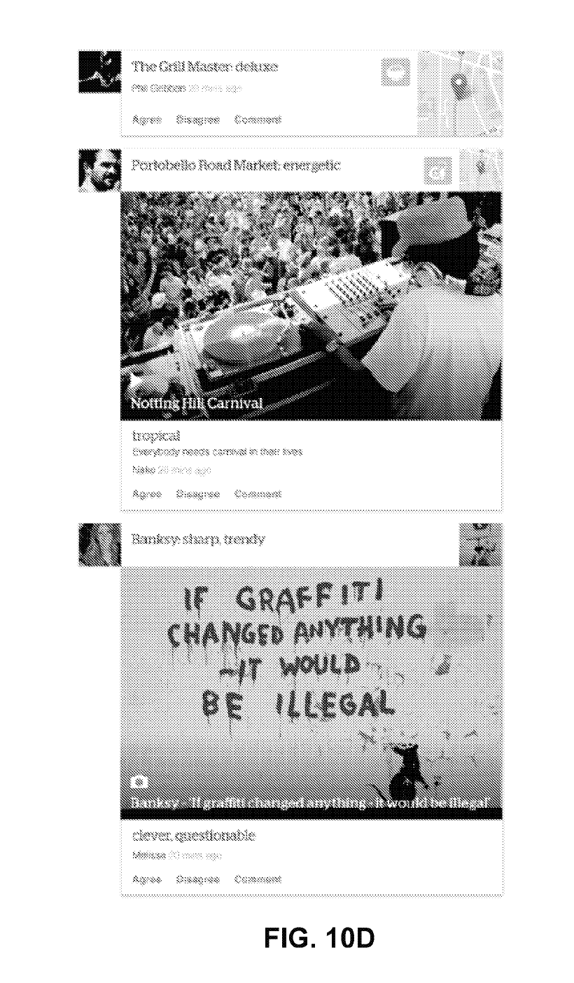

FIG. 9A through FIG. 10D are schematic diagrams depicting aspects of an example graphical user interface (“GUI”) for participating in an interactive opinion flow in accordance with at least one embodiment of the disclosure. As illustrated, FIG. 9A through FIG. 9J depict an example GUI configured for a user 105 to create an opinion and view the immediate results. Similarly, FIG. 10A through FIG. 10D illustrate an example GUI for an opinion stream between one or more users 105.

In the foregoing specification, the disclosure has been described with reference to specific embodiments thereof. It will, however, be evident that various modifications and changes may be made thereto without departing from the broader spirit and scope of the disclosure. For example, the reader is to understand that the specific ordering and combination of process actions described herein is merely illustrative, and the disclosure may be performed using different or additional process actions, or a different combination or ordering of process actions. For example, this disclosure is particularly suited for analyzing opinion data from a Web-based server; however, the disclosure can be used for a variety of opinion mining systems. Additionally and obviously, features may be added or subtracted as desired. Accordingly, the disclosure is not to be restricted except in light of the attached claims and their equivalents.

What is claimed is:

1. A computer-implemented method for analyzing electronic opinion data, said method comprising the steps of:
receiving electronic opinion data, wherein the electronic opinion data includes words of a natural language;
mapping the electronic opinion data to unifying opinion objects, wherein the unifying opinion objects are provided as a controlled natural language and include entity objects, opinion word objects, and subject objects, each of the opinion word objects being descriptive of at least one of the entity objects, and representing an opinion of at least one of the subject objects; and
providing a presentation having at least one portion corresponding to at least one of said unifying opinion objects.

2. The computer-implemented method of claim 1, further comprising ranking the unifying opinion objects in an opinion graph, wherein the opinion graph represents directional relationships between the subject objects and entity objects.

3. The computer-implemented method of claim 2, wherein the opinion graph comprises a social graph, a function graph, and an entity graph.

4. The computer-implemented method of claim 2, wherein the presentation includes a set of opinion results, wherein the set of opinion results are aggregated from a set of ranked related unifying opinion objects of the opinion graph.

5. The computer-implemented method of claim 4, wherein the ranked related unifying opinion objects have in common with the unifying opinion objects at least one of an entity object, a subject object, and an opinion word object.

6. The computer-implemented method of claim 4, further comprising receiving a response from the one or more user devices over said data network, wherein the response is based on the set of opinion results.

7. The computer-implemented method of claim 1, further comprising determining cosms based on an aggregation of unifying opinion objects.

8. The computer-implemented method of claim 7, wherein the cosms are structured according to a structure of the unifying opinion objects.

9. The computer-implemented method of claim 1, wherein the unifying opinion objects have a structure selected from the group comprising: (1) status structure; (2) intent structure; (3) property structure; and (4) connection structure.

10. The computer-implemented method of claim 1, wherein mapping the electronic opinion data to unifying opinion objects further comprises identifying verbs, adjectives, conjunctions, and noun phrases in the electronic opinion data.

11. The computer-implemented method of claim 1, wherein the natural language is English.

12. The computer-implemented method of claim 1, wherein the electronic opinion data includes fragments of sentences of the natural language.

13. The computer-implemented method of claim 1, wherein the opinion data is received from a plurality of Web-based social networking platforms.

14. The computer-implemented method of claim 1, wherein said receiving electronic opinion data further comprises scanning at least one Web page, and wherein said mapping the electronic opinion data further comprises spotting entity objects from the at least one Web page based on a context of the electronic opinion data.

15. The computer-implemented method of claim 1, wherein the electronic opinion data is selected from the group comprising: (1) uniform resource locators (“URLs”); (2) graphics files; (3) video files; and (4) audio files.

16. A network-based system for analyzing electronic opinion data in an opinion network comprising:
an opinion capture server accessible over a data network;
one or more user devices configured to access opinion-enhanced Web services over said data network;
a computer program product operatively coupled to the opinion capture server, the computer program product having a computer-usable medium having a sequence of instructions which, when executed by a processor, causes said processor to execute a process that analyzes electronic opinion data, said process comprising:
receiving electronic opinion data from the one or more user devices, wherein the electronic opinion data includes words of a natural language;
mapping the electronic opinion data to unifying opinion objects, wherein the unifying opinion objects are provided as a controlled natural language and include entity objects, opinion word objects, and subject objects, each of the opinion word objects being descriptive of at least one of the entity objects, and representing an opinion of at least one of the subject objects; and
providing a presentation to the one or more user devices over said data network, wherein the presentation includes at least one portion corresponding to at least one of said unifying opinion objects.

17. The network-based system of claim 16, wherein the process further comprises ranking the unifying opinion objects in an opinion graph, wherein the opinion graph represents directional relationships between the subject objects and entity objects.

18. The network-based system of claim 16, wherein the process further comprises receiving a response from the one or more user devices over said data network with respect to the electronic opinion data.

19. The network-based system of claim 18, wherein the response is selected from the group comprising: (1) agreement; (2) disagreement; (3) questions; and (4) comments.

20. The network-based system of claim 16, wherein the opinion word object is selected from a suggested set of predefined opinion word objects.

21. The network-based system of claim 20, wherein the suggested set of predefined opinion word objects is personalized based on an aggregation of unifying opinion objects.

22. The network-based system of claim 16, further comprising a natural language processor operatively coupled to the opinion capture server, wherein the natural language processor is configured to identify the opinion word objects and entity objects from the unifying opinion objects.

23. The network-based system of claim 22, wherein the natural language processor is configured to identify the opinion word objects and entity objects based on a context of the electronic opinion data.

24. The network-based system of claim 16, wherein the presentation includes suggested unifying opinion objects based on the electronic opinion data.

25. The network-based system of claim 16, wherein the process further comprises determining cosms based on an aggregation of unifying opinion objects.

26. The network-based system of claim 16, wherein the computer program product corresponds to a dashboard widget.

27. The network-based system of claim 26, wherein the presentation includes a natural language description of the subject objects based on the opinion word objects and entity objects.

28. The network-based system of claim 26, wherein the opinion word objects are characterized as positive, negative, or neutral; and wherein the presentation includes a grouping of the entity objects having the most average positive or average negative opinion word objects.

29. The network-based system of claim 26, wherein the opinion word objects are characterized as positive, negative, or neutral; and wherein the presentation includes the entity objects having at least a predefined number of both positive opinion word objects and negative opinion word objects.

30. The network-based system of claim 26, wherein the opinion word objects are characterized as positive, negative, or neutral; and wherein the presentation includes the entity objects having at least a predefined number of both positive opinion word objects and negative opinion word objects and wherein the count of the positive opinion word objects outweigh the negative opinion word objects by a threshold polarity count.

31. The network-based system of claim 26, wherein the opinion word objects are characterized as positive, negative, or neutral; and wherein the presentation includes the entity objects having at least a predefined number of both positive opinion word objects and negative opinion word objects and wherein the count of the negative opinion word objects outweigh the positive opinion word objects by a threshold polarity count.

32. The network-based system of claim 26, wherein the opinion word objects are characterized as positive, negative, or neutral; and wherein the presentation includes the entity objects having the most number of both positive opinion word objects and negative opinion word objects.

33. The network-based system of claim 26, wherein the process further comprises receiving at least one response from the one or more user devices over said data network with respect to the electronic opinion data, and wherein the presentation includes the entity objects of the electronic opinion data having the most number of the at least one response.

34. The network-based system of claim 26, wherein the presentation includes the most frequently used opinion word objects and the corresponding entity objects described.

35. The network-based system of claim 26, wherein the process further comprises receiving at least one response from the one or more user devices over said data network with respect to the electronic opinion data, the one or more user devices each correspond to a subject object; wherein the at least one response is selected from the group comprising: (1) agreement; (2) disagreement; (3) questions; and (4) comments; and wherein the presentation includes the subject objects with the most agreements.

36. The network-based system of claim 26, wherein the opinion word objects are characterized as positive, negative, or neutral; and wherein the presentation includes the entity objects having both of the positive opinion word objects and the negative opinion word objects for a single subject object.

37. The network-based system of claim 26, wherein the dashboard widget is disposed at a third-party Web site.

38. The network-based system of claim 37, wherein the process further comprises notifying the one or more user devices over said data network if the unifying opinion objects are published on the third-party Web site.
